(19) United States
(12) Patent Application Publication
(10) Pub. No.: US 2020/0401326 A1
(43) Pub. Date: Dec. 24, 2020

(54) SEMICONDUCTOR STORAGE DEVICE

(71) Applicant: Kioxia Corporation, Tokyo (JP)

(72) Inventors: Akihisa FUJIMOTO, Yamato (JP); Atsushi KONDO, Yokohama (JP); Hajime SUDA, Yokohama (JP)

(73) Assignee: Kioxia Corporation, Tokyo (JP)

(21) Appl. No.: 17/009,893

(22) Filed: Sep. 2, 2020

Related U.S. Application Data
(63) Continuation of application No. PCT/IB2020/052274, filed on Mar. 13, 2020.

(30) Foreign Application Priority Data
Mar. 20, 2019 (JP) 2019-053326
Jun. 3, 2019 (JP) 2019-103485

(51) Int. Cl. G06F 3/06; G06F 1/28

(52) U.S. Cl. CPC G06F 3/0625; G06F 1/28; G06F 3/0679; G06F 3/0658

(57) ABSTRACT

According to one embodiment, a semiconductor includes a first surface and a second surface. The semiconductor storage device includes a nonvolatile memory, a controller to control the nonvolatile memory, and terminals exposed in the first surface. The controller transmits first data indicative of a temperature of the controller measured by a temperature sensor, second data indicative of a temperature difference between the temperature of the controller and a temperature of the first surface, and third data indicative of a temperature difference between the temperature of the controller and a temperature of the second surface to a host device.

### CROSS-REFERENCE TO RELATED APPLICATIONS

This application is a Continuation Application of PCT Application No. PCT/IB2020/052274, filed Mar. 13, 2020 and based upon and claiming the benefit of priority from Japanese Patent Applications No. 2019-053326, filed Mar. 20, 2019; and No. 2019-103485, filed Jun. 3, 2019, the entire contents of all of which are incorporated herein by reference.

### FIELD

Embodiments described herein relate generally to a semiconductor storage device.

### BACKGROUND

In recent years, nonvolatile memories such as a NAND flash memory have been improved, and thus, storage capacity of nonvolatile memory has been increased. Thus, the semiconductor storage device such as a solid state drive (SSD) has been required to be smaller, thinner, and higher in operation speed.

Note that the amount of heat generated by a high-speed semiconductor storage device is great. Thus, a host device including the high-speed semiconductor storage device requires a heat dissipation mechanism to dissipate the heat in the high-speed semiconductor storage device.

### BRIEF DESCRIPTION OF THE DRAWINGS

FIG. 1 is a plan view illustrating an example of the exterior of a semiconductor storage device and an arrangement of terminals therein.

FIG. 2 is a side view of an example of the semiconductor storage device.

FIG. 3 is a plan view illustrating another example of the arrangement of terminals of the semiconductor storage device.

FIG. 4 is a diagram illustrating an example of signal assignments with respect to the terminals of the semiconductor storage device.

FIG. 5 is a block diagram illustrating an example of the structure of the semiconductor storage device.

FIG. 6 is a diagram illustrating a structure example of the semiconductor storage device.

FIG. 7 is a diagram illustrating thermal management.

FIG. 8 illustrates an example where the semiconductor storage device is placed into a connector of a host device.

FIG. 9 illustrates another example where the semiconductor storage device is placed into a connector of a host device.

FIG. 10 illustrates a thermal resistance model used to calculate a surface temperature (case temperature) of the semiconductor storage device of the first embodiment.

FIG. 11 is a sequence diagram illustrating a procedure of a temperature information output process executed by the semiconductor storage device of the first embodiment.

FIG. 12 is a diagram illustrating an example of SMART/Health Information reported by the semiconductor storage device of the first embodiment to the host device.

FIG. 13 illustrates an example of a relationship between the number of lanes, the number of stacks, read operation, write operation, and power consumption of each of a controller and a nonvolatile memory in the semiconductor storage device of the first embodiment.

FIG. 14 is a flowchart illustrating a process to acquire the number of read operations and the number of write operations executed in a certain period of time.

FIG. 15 is a flowchart of an example of a process to calculate a power ratio between the controller and the nonvolatile memory and a total power consumption of the entire semiconductor storage device on the basis of the number of read operations and the number of write operations with respect to the nonvolatile memory.

FIG. 16 is a diagram illustrating an example of SMART/Health Information reported to a host device by the semiconductor storage device of the first embodiment.

FIG. 17 is a diagram illustrating an example where a semiconductor storage device of a second embodiment is placed into a connector in a host device.

FIG. 18 is a diagram illustrating a heat dissipation model of the second embodiment, corresponding to a connector without a TIM.

FIG. 19 is a diagram illustrating a heat dissipation model of the second embodiment, corresponding to a connector with a TIM.

FIG. 20 is a diagram illustrating an example of SMART/Health Information reported to the host device by the semiconductor storage device of the second embodiment.

FIG. 21 is a sequence diagram illustrating a procedure of a temperature information output process executed by the semiconductor storage device of the second embodiment.

FIG. 22 is a flowchart illustrating an example of a process to calculate a power ratio between the controller and the nonvolatile memory, and a total power consumption of the entire semiconductor storage device, on the basis of the numbers of read operations and the numbers of write operations performed with respect to the nonvolatile memory, the process being executed in the semiconductor storage device of the second embodiment.

### DETAILED DESCRIPTION

Various embodiments will be described hereinafter with reference to the accompanying drawings.

In general, according to one embodiment, a semiconductor storage device which is capable of being placed into a host device includes a first surface and a second surface which is in the opposite side of the first surface. The semiconductor storage device includes a nonvolatile memory, a controller to control the nonvolatile memory, and terminals exposed in the first surface. The terminals include signal terminals used for signal transferring. The controller is configured to transmit first data indicative of a temperature of the controller measured by a temperature sensor, second data indicative of a temperature difference between the temperature of the controller and a temperature of the first surface, and third data indicative of a temperature difference between the temperature of the controller and a temperature of the second surface to the host device, using at least one of the signal terminals.

(Common Configuration)

First, configurations common to the first and second embodiments will be described.

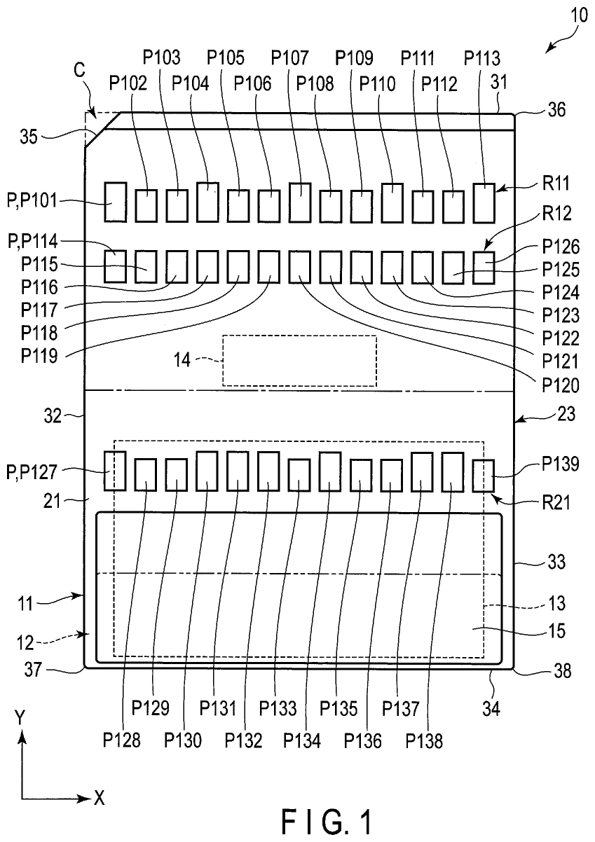

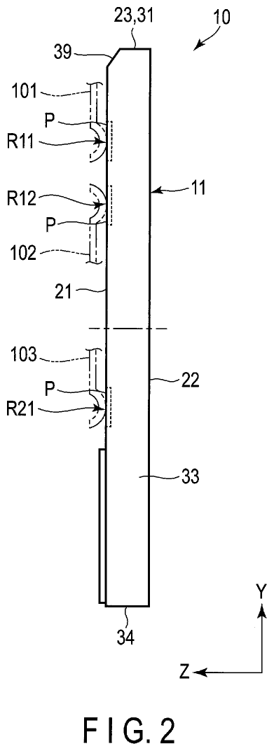

FIG. 1 is a plan view illustrating an example of the exterior of a semiconductor storage device according to the first and second embodiments and an arrangement of terminals of the semiconductor storage device. FIG. 2 is a plan view illustrating an example of the semiconductor storage device.

The semiconductor storage device includes a nonvolatile memory and a controller configured to control the nonvolatile memory. The semiconductor storage device is configured to write to the nonvolatile memory and read data from the nonvolatile memory.

The semiconductor storage device may be realized as a solid state drive (SSD). In that case, the SSD is used as a data storage device of various information processing devices such as a personal computer, and a mobile device which function as a host device.

The semiconductor storage device has a card-like shape, and may function as a removable SSD which can be placed into a connector in the host device (card connector). In the following description, the semiconductor storage device will be referred to as a storage device (card-shaped storage device) 10.

As illustrated in each figure, an X-axis, a Y-axis, and a Z-axis are defined. The X-axis, the Y-axis, and the Z-axis are orthogonal to each other. The X-axis extends along the width of the storage device 10. The Y-axis extends along the length (height) of the storage device 10. The Z-axis extends along the thickness of the storage device 10.

The storage device 10 includes a case 11, printed circuit board 12, NAND flash memory 13, controller 14, and protection sheet 15. The NAND flash memory 13 is an example of the nonvolatile memory.

The storage device 10 and the case 11 are formed in a rectangular plate-like shape extending in Y-axis direction, for example. The Y-axis direction is a longitudinal direction of the storage device 10 and the case 11.

As in FIG. 2, the case 11 has a plate-like shape including a first surface 21, second surface 22, and outer edge 23. The first surface 21 and the second surface 22 are shaped in an approximate quadrangular (rectangular) shape extending in the Y-axis direction. That is, the Y-axis direction is a longitudinal direction of the first surface 21 and the second surface 22.

The first surface 21 is an approximately flat surface facing a positive direction of the Z-axis. As in FIG. 2, the second surface 22 is positioned in the opposite side of the first surface 21, and is an approximately flat surface facing a negative direction of the Z-axis.

The outer edge 23 is positioned between the first surface 21 and the second surface 22, and is connected to the edges of the first surface 21 and the second surface 22. As in FIG. 1, the outer edge 23 includes a first edge 31, second edge 32, third edge 33, fourth edge 34, first corner 35, second corner 36, third corner 37, and fourth corner 38.

The first edge 31 extends in X-axis direction and faces the positive direction of the Y-axis. The X-axis direction is a lateral direction of the storage device 10, case 11, first surface 21, and second surface 22, and includes a positive direction and a negative direction of the X-axis.

The second edge 32 extends in the Y-axis direction and faces the negative direction of the X-axis. The third edge 33 is positioned in the opposite side of the second edge 32, extends in the Y-axis direction, and faces the positive direction of the X-axis. The fourth edge 34 is positioned in the opposite side of the first edge 31, extends in the X-axis direction, and faces the negative direction of axis the Y-axis.

The length of each of the second edge 32 and the third edge 33 is longer than the length of each of the first edge 31 and the fourth edge 34. The first edge 31 and the fourth edge 34 form short sides of the substantially rectangular storage device 10, and the second edge 32 and the third edge 33 form long sides of the substantially rectangular storage device 10.

The first corner 35 is a corner formed by the first edge 31 and the second edge 32, and connects an end of the first edge 31 in the negative direction of the X-axis to an end of the second edge 32 in the positive direction of the Y-axis.

The first corner 35 extends linearly between the end of the first edge 31 in the negative direction of the X-axis and the end of the second edge 32 in the positive direction of the X-axis. The corner formed by the first edge 31 and the second edge 32 is set as a so-called corner chamfering of C1.1 (C chamfering) to provide the first corner 35. In other words, the first corner 35 is a chamfer portion C formed between the first edge 31 and the second edge 32.

The second corner 36 is a corner between the first edge 31 and the third edge 33, and connects an end of the first edge 31 in the positive direction of the X-axis to an end of the third edge 33 in the positive direction of the Y-axis. The second corner 36 is an arch-shaped corner portion that extends between the end of the first edge 31 in the positive direction of the X-axis and the end of the third edge 33 in the positive direction of the Y-axis. The corner formed by the first edge 31 and the third edge 33 is set as a so-called round chamfering of R0.2 (R chamfering) to provide the second corner 36. As can be understood from the above, the shape of the first corner 35 is different from that of the second corner 36.

The third corner 37 connects an end of the second edge 32 in the negative direction of the Y-axis to an end of the fourth edge 34 in the negative direction of the X-axis. The fourth corner 38 connects an end of the third edge 33 in the negative direction of the Y-axis and an end of the fourth edge 34 in the positive direction of the X-axis. The third corner 37 and the fourth corner 38 are arch-shaped corner portions

The storage device 10, case 11, first surface 21, and second surface 22 are formed such that the length in the Y-axis direction becomes approximately 18±0.1 mm, and the length in the Y-axis direction becomes approximately 14±0.1 mm. That is, a distance (gap) between the first edge 31 and the fourth edge 34 in the Y-axis direction is set to approximately 18±0.1 mm, and a distance (gap) between the second edge 32 and the third edge 33 in the X-axis direction is set to approximately 14±0.1 mm. Note that the lengths of the storage device 10, case 11, first surface 21, and second surface 22 in the X-axis direction and the Y-axis direction are not limited to this example.

As in FIG. 2, the case 11 includes an inclined portion 39. The inclined portion 39 is a corner part formed by the first surface 21 and the first edge 31 and extends linearly between an end of the first surface 21 in the positive direction of the Y-axis and an end of the first edge 31 in the positive direction of the Z-axis.

As in FIG. 1, the printed circuit board 12, NAND flash memory 13, and controller 14 are disposed inside the case 11. The printed circuit board 12, NAND flash memory 13, and controller 14 may be contained in the box-shaped case 11, or may be embedded in the case 11. The NAND flash memory 13 and the controller 14 are mounted on the surface of the printed circuit board 12.

Note that the printed circuit board 12 may form a part of the case 11 such that the back surface of the printed circuit board 12 is exposed. In that case, the back surface of the printed circuit board 12 can function as the first surface 21.

The controller 14 controls the NAND flash memory 13 and the entire storage device 10 including the NAND flash memory 13. For example, the controller 14 can control a read/write operation with respect to the NAND flash memory 13 and a communication with an external device. The control of communication includes a protocol control corresponding to PCI Express (PCIe) (registered trademark).

The protection sheet 15 is adhered to the first surface 21. The protection sheet 15 seals, for example, test terminals exposed in the first surface 21.

The storage device 10 further includes a plurality of terminals P. The terminal P may be referred to as a pad. The storage device 10 includes 26 or 39 terminals P. Note that, the number of terminals P is a mere example, and is not limited thereto. That is, the number of terminals P may be less than 26 or may be greater than 39. The terminals P are provided on, for example, the back surface of the printed circuit board 12. The terminals P are formed on the printed circuit board 12, and are exposed in the first surface 21. The second surface 22 does not include the terminals P and may be used as, for example, marking surface or heat radiation surface. The storage device 10 includes a terminal (pad) group for a row R11 and a terminal (pad) group for a row R12. In R11 and R12, thirteen pads are adopted as the pads that enable PCIe_2 lane to be mounted in each row.

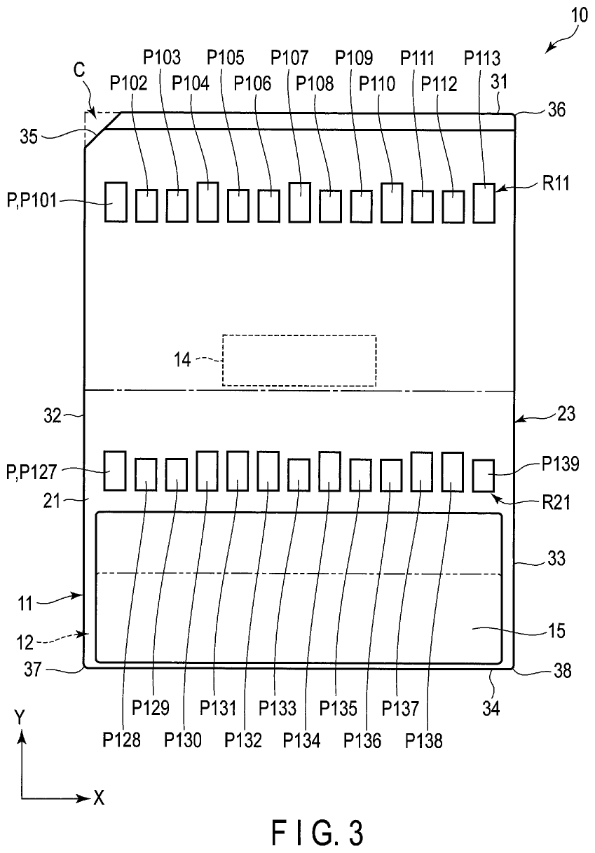

The terminals P are aligned in three rows to form rows R11, R12, and R21. Terminal groups in the rows R11 and R12 are used as signal terminals to transfer differential signal pairs of four lanes conforming to the PCIe standard. Terminal group in the row R21 is mainly used as power supply terminals and other signal terminals. Note that, if the number of lanes supported by the storage device 10 is two, the storage device 10 may include 26 terminals P forming the rows R11 and R21 aligned in two rows as in FIG. 3. Terminal group in the row R11 is used as signal terminals to transfer differential signal pairs of two lanes.

As in FIG. 1, row R11 includes thirteen terminals P101 to P113 spaced apart from each other and arranged in the X-axis direction, at positions closer to the first edge 31 than to the fourth edge 34. The terminals P101 to P113 are arranged in the X-axis direction along the first edge 31 at positions near the first edge 31.

The row R12 includes thirteen terminals P114 to P126 spaced apart from each other and arranged in the X-axis direction, at positions closer to the first edge 31 than to the fourth edge 34. The terminals P114 to P126 forming the row R12 are arranged at positions farther from the first edge 31 than from the row R11. For this reason, the row R12 is farther from the first edge 31 than from the row R11. The row R11 and the row R12 are spaced apart with a predetermined short interval and arranged in the Y-axis direction.

The row R21 includes 13 terminals P127 to P139 spaced apart from each other and arranged in the X-axis direction, at positions closer to the fourth edge 34 than to the first edge 31. The terminals P127 to P139 forming the row R21 are located at positions closer to the fourth edge 34 than to the first edge 31. In other words, the terminals P127 to P139 forming the row R21 are arranged between a center line (represented by a one-dot chain line) of the storage device 10 and the case 11 in the Y-axis direction and the fourth edge 34. Thus, the gap between the rows 12 and 21 is widened. The terminals P forming the row R21 are become distant from the center line.

The distance between adjacent terminals P in the X-axis direction is determined, if the length between the second edge 32 and the third edge 33 is constant, based on the number of terminals P, for example. Furthermore, based on the minimum distance between adjacent terminals P in the X-axis direction, the maximum number of terminals P arranged in the X-axis direction is determined. The minimum distance is determined in consideration of manufacturing tolerances of terminals P of the storage device 10 and contacts (pins) of the connector. The distances between terminals P in the X-axis direction may be even or may be different. The number of terminals P in each of the rows R11, R12, and R21 is the same. Thus, the distance between all terminals P is constant.

In each of the rows R11, R12, and R21, the terminals P are arranged such that edges of the terminals P are aligned in a negative direction of the Y-axis.

As to the signal terminals P of the rows R11 and R12, the length of the terminals P in the Y-axis direction is set to be equal. Electric properties of the terminals P for data transfer of the row R11 and the row R12 can be thereby made similar.

Moreover, one terminal P may protrude in the positive direction of the Y-axis rather than the edges of the other terminals P in the positive direction of the Y-axis. For example, when the terminal P for power supply and the terminal P for GND protrude rather than the signal terminals P, the terminals P for power supply and for GND are in contact with a lead frame of the connector faster than the signal terminals P, in a lateral insertion type connector to which the storage device 10 is inserted in the positive direction of the Y axis. Thus, the GND level of the host device and the GND level of the storage device 10 become equivalent and the electric level of the controller 14 can be made stable.

A large number of signals can hardly be output from the lateral insertion type connector. For this reason, it is assumed that R12 is not used for data transfer, in the lateral insertion connector. Thus, GND terminals and power supply terminals are longer only in R11 and R21.

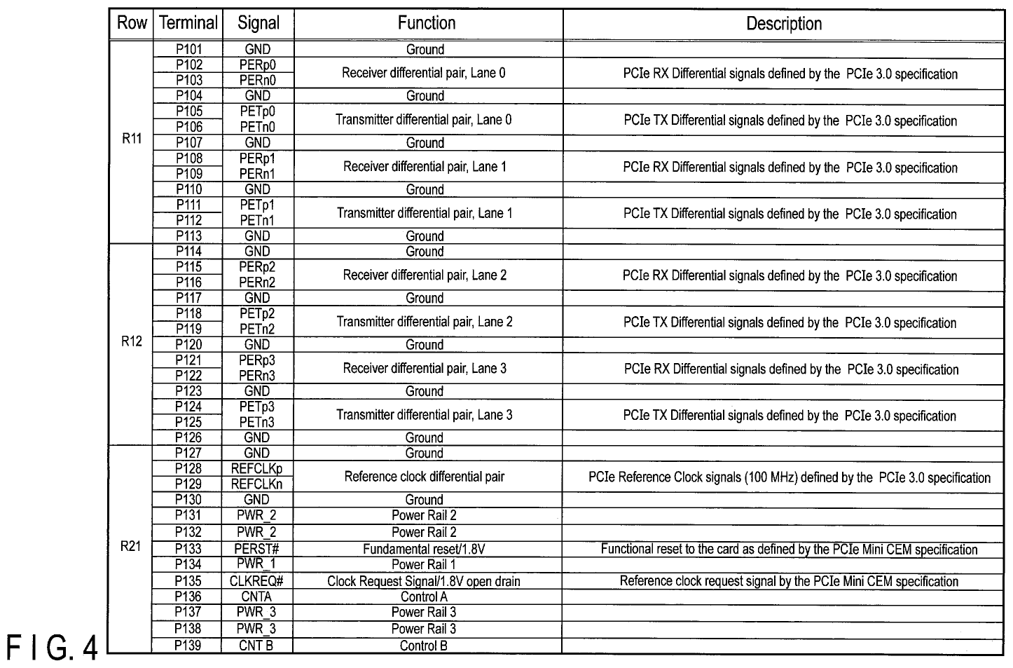

FIG. 4 illustrates an example of signal assignments with respect to the terminals P. As in FIG. 4, signals used for high-speed serial data transfer of PCIe are assigned to the terminals P of the row R11 and the row R12. In PCIe, differential signal pairs can be used for data transfer.

In row R11, grands (GNDs) are assigned to terminals P101, P104, P107, P110, and P113, receiver differential signals PERp0, PERn0, PERp1, and PERn1 are assigned to terminals P102, P103, P108, and P109, and transmitter differential signals PETp0, PETn0, PETp1, and PETn1 to terminals P105, P106, P111, and P112.

In row R12, grands (GNDs) are assigned to terminals P114, P117, P120, P123, and P126, receiver differential signals PERp2, PERn2, PERp3, and PERn3 are assigned to terminals P115, P116, P121, and P122, and transmitter differential signals PETp2, PETn2, PETp3, and PETn3 are assigned to terminals P118, P119, P124, and P125.

A pair of terminals P102 and P103 to which receiver differential signals PERp0 and PERn0 are assigned are positioned between two terminals P101 and P104 to which grands are assigned, and are sandwiched between the terminals P101 and P104. A pair of terminals P105 and P106 to which transmitter differential signals PETp0 and PETn0 are assigned are positioned between two terminals P104 and P107 to which grands are assigned, and are sandwiched between the terminals P104 and P107.

A pair of terminals P108 and P109 to which receiver differential signals PERp1 and PERn1 are assigned are positioned between two terminals P107 and P110 to which grands are assigned, and are sandwiched between the terminals P107 and P110. A pair of terminals P111 and P112 to which transmitter differential signals PETp1 and PETn1 are assigned are positioned between two terminals P110 and P113 to which grands are assigned, and are sandwiched between the terminals P110 and P113.

A pair of terminals P115 and P116 to which receiver differential signals PERp2 and PERn2 are assigned are positioned between two terminals P114 and P117 to which grands are assigned, and are sandwiched between the terminals P114 and P117. A pair of terminals P118 and P119 to which transmitter differential signals PETp2 and PETn2 are assigned are positioned between two terminals P117 and P120 to which grands are assigned, and are sandwiched between the terminals P117 and P120.

A pair of terminals P121 and P122 to which receiver differential signals PERp3 and PERn3 are assigned are positioned between two terminals P120 and P123 to which grands are assigned, and are sandwiched between the terminals P120 and P123. A pair of terminals P124 and P125 to which transmitter differential signals PETp3 and PETn3 are assigned are positioned between two terminals P123 and P126 to which grands are assigned, and are sandwiched between the terminals P123 and P126.

In PCIe, one lane can be composed of a set of the transmitter differential signals PETp0 and PETn0 and the receiver differential signals PERp0 and PERn0. In addition, in PCIe, one lane can be further composed of a set of the transmitter differential signals PERp1 and PETn1 and the receiver differential signals PERp1 and PERn1. Similarly, one lane can be further composed of a set of the transmitter differential signals PETp2 and PETn2 and the receiver differential signals PERp2 and PERn2, and one lane can be further composed of a set of the transmitter differential signals PETp3 and PETn3 and the receiver differential signals PERp3 and PERn3. Two lanes are assigned to terminals P forming the row R11 and two lanes are further assigned to terminals P forming the row R12.

Control signals other than differential signals of PCIe are assigned to terminals P of the row R21. In the row R21, reference differential clock signals REFCLKp and REFCLKn are assigned to terminals P128 and P129, GNDs are assigned to terminals P127 and P130 such that clock terminals P128 and P129 are sandwiched between the GND terminals P127 and P130, and second power supply voltage (power rail) PWR2 is assigned to terminals P131 and P132, reset signal PERST # is assigned to terminal P133, first power supply voltage (power rail) PWR1 is assigned to terminal P134, clock control signal CLKREQ # is assigned to terminal P135, control signals CNTA and CNTB are assigned to terminals P136 and P139, and third power supply voltage (power rail) PWR3 is assigned to terminals P137 and P138.

With the plural terminals P functioning as power supply terminals, the current can be dispersed, the current flowing per one power supply terminal can be made smaller, and a drop voltage caused by a resistance component existing between a power supply circuit of the host device and the power supply terminals can be made smaller.

A PCIe reference differential clock signal (reference clock) REFCLKp/n forms a differential clock signal. By transferring clock signals of MHz frequency bandwidth to terminals P128 and P129 from the host device, the storage device 10 does not require a highly accurate clock oscillator attached thereto, and thus, synchronization between the host device and the storage device 10 can be simplified. Furthermore, occurrence of electromagnetic interference (EMI) can be suppressed by lowering the frequencies of the clock signals used for transmission to the terminals P128 and P129 to make their waveforms similar to a sine wave. A method of suppressing EMI by spreading spectrum through clock fluctuation, which is called spread spectrum clocking (SSC), may be adopted. The storage device 10 generates high frequencies of the differential signals by which the terminals P102, P103, P105, P106, P108, P109, P111, P112, P115, P116, P118, P119, P121, P122, P124, and P125 are used for transmission, by multiplying the received clock by the PLL circuit.

The reset signal PERST # is used by the host device to start and reset the storage device 10 communicating in accordance with the PCIe standard. The clock control signal CLKREQ # is a control signal to request the host device to supply a reference differential clock. This signal is temporarily set to a High level (i.e., becomes High by pull-up for open drain) after the power supply voltage is supplied to the storage device 10, and is driven to a Low level at a stage where the power supply voltage in the storage device 10 becomes stable and is able to receive a clock. Upon detection of CLKREQ # as a Low level, the host device starts supplying the reference clock. Furthermore, the host device can use this signal as a signal to control the storage device 10 to transition to the power saving mode of the storage device 10 and return from the power saving mode. The storage device 10 can reduce power consumption of PHY by entering the power saving mode when the storage device 10 is in an idle state where a memory access to the NAND flash by the controller 14 is not executed. The host device can stop the reference clock signal REFCLKp/n in the power saving mode, and the storage device 10 also has a mode of turning off the common power supply of PHY and can remarkably reduce the power consumption of the storage device 10.

The reset signal PERST # and the clock request signal CLKREQ # are single end signals and defined as side band signals of PCIe.

The host device can supply a power supply voltage PWR1 to the terminal P134 as a first power source. The power supply voltage PWR1 may be set to 3.3 V. The host device can supply a power supply voltage PWR2 to the terminals P131 and P132 as a second power source. The power supply voltage PWR2 may be set to 1.8 V. The host device can supply a power supply voltage PWR3 to the terminals P137 and P138 as a third power source. The power supply voltage PWR3 may be set to 1.2 V.

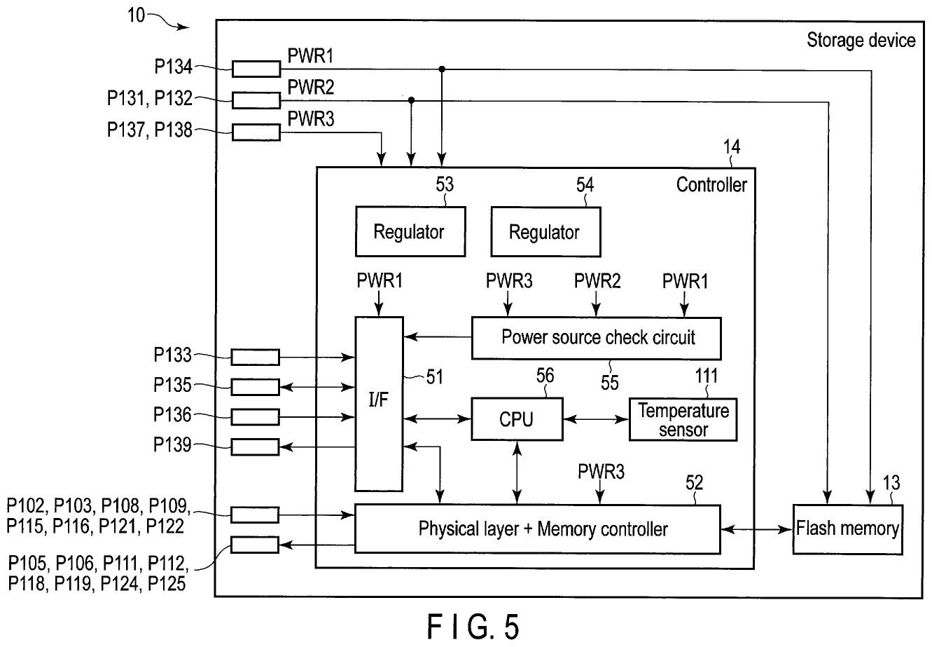

FIG. 5 is a block diagram schematically illustrating an example of the structure of the storage device 10.

The controller 14 includes an interface circuit (I/F) 51, physical layer and memory controller 52, two regulators 53 and 54, power supply check circuit 55, CPU 56, and temperature sensor 111.

The interface circuit (I/F) 51 can transmit and receive single end signals such as PERST #, CLKREQ #, CNTA, and CNTB. The physical layer and memory controller 52 includes a receiver and a transmitter. The receiver includes a circuit to receive receiver differential signals PERp0, PERn0, PERp1, PERn1, PERp2, PERn2, PERp3 and PERn3. The transmitter includes a circuit and the like to transmit data as transmitter differential signals PETp0, PETn0, PETp1, PETn1, PETp2, PETn2, PETp3, and PETn3.

The physical layer and memory controller 52 can perform serial/parallel conversion, parallel/serial conversion, and symbol encoding of data. The symbol encoding is a process to suppress the number of continued same values below a certain number by replacing, when 0s or 1s of data continue, the data with symbols in which 0s or 1s do not continue, the symbols being included in codes of 8b/10b or 128b/130b. By this symbol encoding, a bias of the voltage level at the time of data transferring can be suppressed. Furthermore, when the same symbol pattern is transferred repeatedly, harmonics of a specific frequency increases; however, by switching to symbols of different patterns to avoid the repeating patterns, the harmonics of a specific frequency can be prevented from increasing. That is, occurrence of EMI can be suppressed.

In a transaction layer of PCIe, packetized data can be transmitted and received, and message can be transmitted and received. In a data link layer of PCIe, a sequence number can be added to the packet received from the transaction layer, and a CRC code can be added to the packet received from the transaction layer. The sequence number may be used in confirmation of sending of the packet.

PCIe can be formed of a plurality of lanes, and each lane connecting between the host device and the storage device 10 is independently initialized. Only the lanes after the completion of initialization and able to perform communication are used. In the storage device 10, four lanes are used at the maximum; however, only 1 Lane or 2 Lanes may be used.

| | |
|---|---|
| 1 Lane: | PERp0, PERn0, PETp0, PETn0 |

| | |
|---|---|
| (or, | PERp1, PERn1, PETp1, PETn1) |

| | |
|---|---|
| 2 Lanes: | PERp0, PERn0, PETp0, PETn0 |
| | PERp1, PERn1, PETp1, PETn1 |
| 4 Lanes: | PERp0, PERn0, PETp0, PETn0 |
| | PERp1, PERn1, PETp1, PETn1 |
| | PERp2, PERn2, PETp2, PETn2 |
| | PERp3, PERn3, PETp3, PETn3 |

The power supply voltage PWR1 (3.3 V) is supplied to the NAND flash memory 13 and the controller 14. In the storage device 10, the power supply voltage PWR1 is mainly used for the operation of the NAND flash memory 13 such as read/write from/to the NAND flash memory 13. By boosting-up the power supply voltage PWR1, a program voltage of the NAND flash memory 13 is generated. Furthermore, the power supply voltage PWR1 may be used for other purposes.

If the host device and the storage device 10 are connected with 3.3 V signal voltage, the power supply voltage PWR1 is used as a power supply voltage for I/O of the signals. Even if the host device and the storage device 10 are connected with 1.8 V signal voltage, the power supply voltage PWR1 may be used as the power supply voltage for I/O. Thereby, the storage device 10 becomes resistive against high voltage, and input circuit is protected. The storage device 10 can be, for example, if the power supply voltage PWR1 is set to 2.5 V, 2.5 V resistive, and if the power supply voltage PWR1 is set to 3.3 V, 3.3 V resistive.

Power supply voltage PWR2 (1.8 V) is supplied to the NAND flash memory 13 and the controller 14. In the storage device 10, the power supply voltage PWR2 is used as power of a logic circuit. Furthermore, the power supply voltage PWR2 may be used as an interface voltage between the NAND flash memory 13 and the controller 14.

If the host device and the storage device 10 are connected with 1.8 V signal voltage, the power supply voltage PWR2 may be used as the power supply voltage for I/O. In that case, the storage device 10 is 1.8 V signaling resistive. The power supply voltage PWR1 may be used as the power supply voltage for I/O and still I/O has 1.8 V signaling threshold for input. In that case, the storage device 10 is 3.3 V signaling resistive.

Power supply voltage PWR2 (1.8 V) and PWR3 (1.2 V) are supplied to the controller 14. In the storage device 10, the power supply voltage PWR2 is used as a power supply voltage for an analogue circuit of a physical layer (PHY). The power supply voltage PWR3 is used for logic circuits.

Generally, power supplies for analogue circuits and digital logic circuits are separated. A power supply with lower noise is created by an internal voltage regulator from PWR2 for the analogue circuits. A power supply lower than PWR3 voltage is created by an internal voltage regulator from PWR3 for logic circuits.

As can be understood from the above, in the storage device 10, for example, three power supply voltages PWR1, PWR2, and PWR3 are supplied separately. That is, three power supply voltages PWR1, PWR2, and PWR3 are used for different purposes. In that case, the power supply circuit of the device 10 is simplified while three power supply circuits are required in the host side. Note that the power supply voltages PWR1, PWR2, and PWR3 may not be limited to the above examples, and may be used in different ways.

For example, one power supply method in which only the power supply voltage PWR1 is supplied may be adopted or two-power supply method in which PWR1 and PWR2 are supplied may be adopted. In that case, a down converter type DC-DC converter or a voltage regulator (LDO) is used as a power supply circuit in the storage device 10. With the voltage regulator, a power supply voltage which is lower than an input voltage can be generated. In that case, power loss by the voltage regulator is determined by a current which flows in the voltage regulator and the difference between input voltage and output voltage. Although a power supply circuit is required in the storage device 10, a power supply voltage of lower noise can be used, and the power supply circuit in the host device can be simplified.

For example, in FIG. 5, the power supply voltage PWR1 or PWR2 may be supplied to the regulator 53 or 54. Thus, a voltage lower than PWR1 can be generated from PWR1, and a voltage lower than PWR2 can be generated from PWR2.

The power supply voltages PWR1, PWR2, and PWR3 are input in the power supply check circuit 55. The power supply check circuit 55 sets CLKREQ # to Low level when the storage device 10 is operable by the power supply voltages PWR1, PWR2, and PWR3. On the other hand, the power supply check circuit 55 maintains CLKREQ # as High level when the storage device 10 is not operable by power supply voltages PWR1, and PWR2 (a structure without regulators).

CPU 56 is a processor configured to control each component in the controller 14, and can execute various processes by executing a program (firmware) stored in a ROM which is not shown or the NAND flash memory 13. For example, if a command (Get SMART/Health Information) is received from the host device, CPU 56 executes a process to acquire a temperature from the temperature sensor 111, a process to calculate a power ratio, a process to calculate a total power consumption Pt, a process to calculate Tc′ and Tb′ from the total power consumption Pt, and a process to transmit SMART/Health Information including Tc′ and Tb′ to the host device and to report various status of the storage device 10 to the host device, for example.

The storage device 10 is placed into a connector included in the host device. The connector is a card connector which connects the card-like shaped storage device 10 to a system board of the host device, and for example, the connector may be a push-push type connector, a push-pull type connector, a hinge type or a tray type connector.

When the storage device 10 is inserted into the connector of the host device, as in FIG. 2, lead frames 101, 102, and 103 of the connector contact the terminals P forming the rows R11, R12, and R21.

When the lead frames 101, 102, and 103 contact the terminals P, a controller provided with the system board of the host device (hereinafter will be referred to as host controller) and the controller 14 of the storage device 10 are electrically connected. Interface for inter-connecting between the host device and the storage device 10 may be, for example, NVM Express (NVMe) (registered trademark). In that case, the storage device 10 is connectable to the host device in accordance with a NVMe specification.

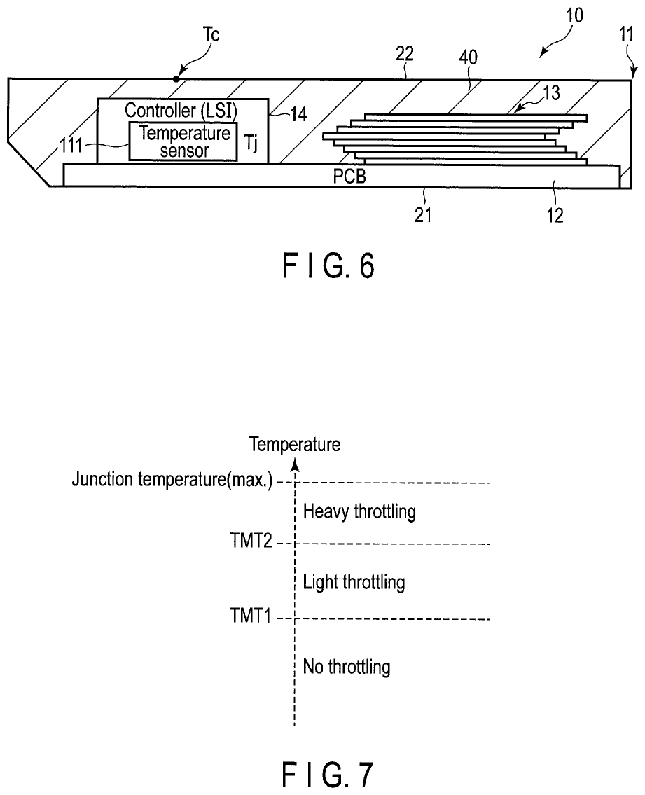

FIG. 6 illustrates an example of the structure of the storage device 10.

In the storage device 10, the NAND flash memory 13 and the controller 14 are disposed on the printed circuit board 12. The NAND flash memory 13 may include a plurality of NAND flash memory chips stacked. Generally, the plurality of NAND flash memory chips function in an interleave operation. The controller 14 is an LSI.

The storage device 10 is a card-shaped package. That is, the storage device 10 is realized as a package (memory package) having a card-like shape, and the NAND flash memory 13 and the controller 14 are covered with a mold resin 40 that is molded to form the body (i.e., case 11) of the storage device 10 and are thereby sealed.

The controller 14 includes a temperature sensor 111. The temperature sensor 111 may be formed of, for example, a thermistor and an A/D converter which are included in the controller 14. Resistance of the thermistor is changed in accordance with temperature. The relation between resistance and temperature can be expressed by a simple approximation formula. By supplying voltage to the thermistor and a resistance connected to the thermistor in series, the change of the resistance of the thermistor, caused by change of temperature, becomes the change of the voltage at a connecting point of the thermistor and the resistance. By the A/D converter, a value of the voltage is converted to digital data which is capable of being processed by software. Also, temperature can be obtained from the value of the voltage on the basis of the correlation between temperature changes and voltage changes. The temperature sensor 11 measures a temperature of the controller 14.

The plurality of NAND flash memory chips function in an interleave operation while the controller 14 continues to operate constantly. Thus, the temperature of the controller 14 tends to be higher than that of the NAND flash memory 13.

The temperature sensor 111 is disposed within the controller 111, and thus, the temperature sensor 111 can measure the temperature in the controller 14. If the temperature sensor 111 is placed around the highest temperature area of the controller 14, which becomes the highest temperature in the device 10, a junction temperature may be measured by the temperature sensor 111.

The storage device 10 can operate in any one power state selected from plural power states in which power consumptions and performances are different from each other. For example, the storage device 10 may function in power state 0, power state 1, or power state 2. Power state 0 consumes more power than power state 1. Power state 1 consumes more power than power state 2. When the power consumption is greater, the performance of the storage device 10 becomes greater. The storage device 10 can transit to a lower power state in accordance with the idle time, and the power consumption of the storage device 10 can be thereby reduced.

Since the storage device 10 is a card-like shaped device in which the surface area for heat dissipation is small, and further, the storage device 10 is a high-speed device consumes a large power, the temperature in the controller 14 becomes relatively high. When the storage device 10 of greater heat generation is used in the host device, dissipating heat to the atmosphere is insufficient for cooling the storage device 10. Therefore, the host device requires a heat dissipation mechanism configured to reduce the internal temperature of the storage device 10 by using heat conduction.

The storage device 10 has a function so-called thermal throttling to prevent the internal temperature from exceeding a limit temperature by reducing memory access frequency, in order to prevent destruction of the device 10 (especially flash memory 13) and decrease of life of the device 10 (especially flash memory 13) which are caused by high heat generated by the device 10.

In general, an internal temperature of the controller 14 differs from that of the NAND flash memory 13, the internal temperature of the storage device 10 is controlled such that the internal temperature of the storage device 10 does not exceed the junction temperature (max.1) of the controller 14 and the junction temperature (max.2) of the NAND flash memory 13. The junction temperature (max.1) is a maximum operation temperature of the controller 14 and the junction temperature (max.2) is a maximum operation temperature of the NAND flash memory 13. If the internal temperature of the NAND flash memory 13 exceeded the junction temperature (max.2) of the NAND flash memory 13, the data retaining performance of the NAND flash memory 13 would be compromised. In general, the junction temperature (max.2) of the NAND flash memory 13 is lowered than the junction temperature (max.1) of the controller 14.

The total power consumption Pt of the storage device 10 is a power consumption of the entire storage device 10, and is a sum of a power consumption Pc of the controller 14 and power consumption Pn of the NAND flash memory 13. Pc and Pn are related to the number of memory read/write operations in a certain period (explained later).

Pt=Pc+Pn

A ratio between the power consumption Pc of the controller 14 and the power consumption Pn of the NAND flash memory 13 changes in accordance with the operation state of the storage device 10. A ratio of the power consumption Pc to the total power consumption Pt is referred as a power ratio. The power ratio r is represented as follows.

r=pc/(Pc+Pn)−pc/pt

In general, it is difficult that the controller 14 acquires the internal temperature of the NAND flash memory 13 in real time (for example, during data transfer of the NAND flash memory 13). The controller 14 can estimate the internal temperature of the NAND flash memory 13 from the power consumption Pc of the controller 14 using the power ratio r.

Pn=(1−r)/r×pc

Thus, the controller 14 calculates the internal temperature of the NAND flash memory 13 using the power ratio r and the internal temperature Tj of the controller 14, and performs the throttling control to reduces the number of read/write to the NAND flash memory 13 such that the internal temperature of the NAND flash memory 13 does not exceed the junction temperature (max.2).

Further, the storage device 10 has a function so-called “host controlled thermal management” of NVM Express Version 1.3 may be used.

As shown in FIG. 7, two temperature threshold values (a thermal management temperature TMT1, a thermal management temperature TMT2) are used. TMT1 is a temperature threshold at the time of starting “light throttling” in which reducing of the performance of the storage device 10 is small. TMT2 is a temperature threshold at the time of starting “heavy throttling” in which reducing of the performance of the storage device 10 is large. Since the performance of the storage device 10 is gradually decreased in two steps by using the two temperature threshold values, a sudden steep decline of the performance can be prevented, and a thermal balanced state is easily established and the operation becomes stable. In general, since the start of changing of the temperature is delayed, the temperature of the storage device 10 starts to change after the temperature control is started, and thus, stabilization of temperature of the storage device 10 becomes difficult to perform in an active control. TMT1 and TMT2 are designated based on the internal temperature of the storage device 10. Therefore, the set values of TMT1 and TMT2 differ in accordance with the implementation of the storage device 10. Furthermore, TMT1 and TMT2 are set to be temperatures lower than the junction temperature (max) used for moderate performance reduction. If the internal temperature of the storage device 10 exceeds the thermal management temperature TMT1 or TMT2, the storage device 10 can take a measure such as transition to any power state of less power consumption.

However, an element influencing the surface temperature of the case of the host device is the surface temperature of the case 11 of the storage device 10, specifically, the surface temperature (case surface temperature, or case temperature) of the upper surface (second surface 22) of the case 11, and the surface temperature (case surface temperature, or case temperature) of the lower surface (first surface 21) of the case 11.

Normally, the internal temperature of the controller 14 measured by the temperature sensor 111 is higher than the surface temperature on the second surface 22. This is because the heat of the controller 14 of the storage device 10 is removed through the heat conductive materials on the second surface 22. Since the heat inside transfers to the outside, a temperature gradient indicating that the inside has a high temperature and the outside has a low temperature occurs. The magnitude of the temperature gradient depends on the heat conductivity of materials used in the case or the like.

As can be understood from the above, the internal temperature of the controller 14 is insufficient as information to optimize the heat dissipation mechanism of the host device.

In case where a structure to report the internal temperature of the controller 14 measured by the temperature sensor 111 to the host device is adopted for thermal control by the host device, a conflict between the thermal control by the host device and the thermal management (thermal throttling) by the storage device 10 may occur. In that case, the performance of the storage device 10 may be deteriorated more than expected.

A structure to dispose a temperature sensor in the proximity of the second surface 22 may be adoptable. However, this structure requires a temperature sensor which is a different component from the NAND flash memory 13 and the controller 14 in addition thereto to be disposed in the storage device 10. Thus, this structure is not suitable for the storage device 10 which is realized as a card-like shaped memory package.

The junction temperature varies with the technologies and designs adopted by the controller 14 and the flash memory 13, and therefore if the temperature is controlled using the internal temperature, the temperature control needs to be customized. In order to generalize the temperature control, the temperature of the storage device 10 is specified by surface temperature and the maximum power consumption. For example, the upper limit of the surface temperature at which the storage device 10 can be operated at the maximum performance can be set, or the surface temperature at which the internal temperature reaches the junction temperature can be set. In the former case, this upper limit is not an absolute upper limit, and when the temperature may exceed the limit, thermal throttling occurs to lower the performance. In the latter case, the thermal throttling of the storage device 10 itself occurs not to increase the surface temperature any further.

In the designing of the heat dissipation mechanism of the host device, it is preferable to cool the storage device 10 such that it has the surface temperature specified or lower when operated at the maximum power consumption for the storage device 10 to be used at the maximum performance. If it is difficult, it can as well be adjusted to such a level that the degradation in the performance, caused by the throttling of TMT1 can be permitted. Here, it is necessary to design a heat dissipation mechanism that can dissipate the heat generated by the maximum power consumption of the storage device 10 by heat conduction through the surface of the device 10.

In order for the host device to know the surface temperature of the storage device 10, a temperature sensor may be installed in the connector (card connector). Thus, the surface temperature of the storage device 10 can be measured. However, it is not easy to amount a temperature sensor in the connector, and the product cost may increase. The storage device 10 can be provided with a function of obtaining a correlation between the internal temperature and the surface temperature, and of reporting the surface temperature.

Thus, in the first embodiment, when a request to acquire a temperature is received from the host device, the controller 14 calculates the surface temperature of the second surface 22 from the temperature of the controller 14 (that is, temperature measured by the temperature sensor 111) based on a thermal resistance model related to the heat dissipating from the controller 14 to the outside of the case 11. Then, the controller 14 transmits the surface temperature of the second surface 22 to the host device.

In that case, as the surface temperature of the second surface 22, a surface temperature of a position on the second surface 22 above the controller 14 (Tc of FIG. 6) can be acquired. As described above, the temperature of the controller 14 tends to be higher than that of the NAND flash memory 13. Thus, the surface temperature of the position on the second surface 22 above the controller 14 (for example, directly above the controller 14) tends to be higher than the surface temperature of a position on the second surface 22 above the NAND flash memory 13 (for example, directly above the NAND flash memory 13).

Thus, in the first embodiment, the controller 14 calculates, based on the temperature of the controller 14, the surface temperature (Tc of FIG. 6) of the position on the second surface 22 which is above the controller 14, and reports Tc to the host device. Thus, the highest temperature on the second surface 22 can be reported to the host device. Similarly, the surface temperature at the position on the second surface 22 located above (for example, immediately above) the NAND flash memory 13 can also be reported from the measured value of the temperature sensor of the NAND flash memory 13.

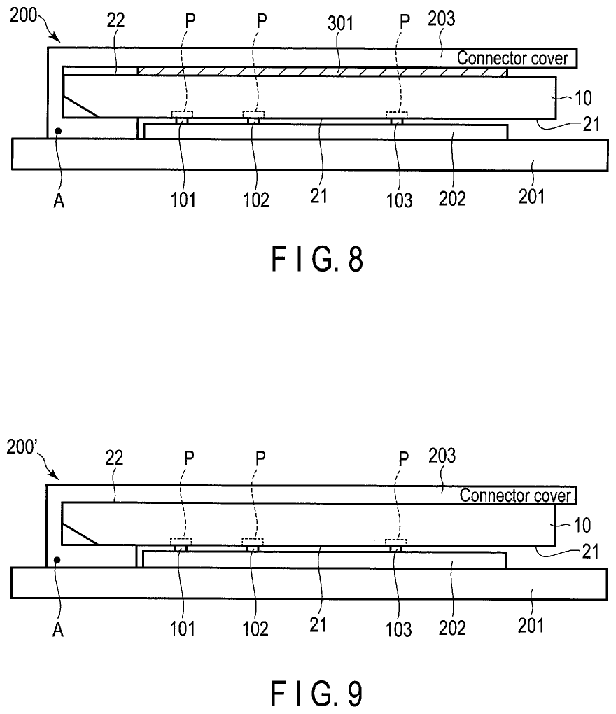

FIG. 8 illustrates an example of a state where the storage device 10 is placed into the connector of the host device.

As described above, although the type of connector is not limited, a hinge type connector 200 is used in this embodiment. The connector 200 is used to connect the storage device 10 to the system board of the host device. The connector 200 may include a base part 201, wiring board 202, and connector cover 203.

The connector cover 203 may be attached to the base part 201 to rotate about axis A which functions as a hinge part between an open position where the upper surface of the wiring board 202 is exposed and a close position where the wiring board 202 is covered with the connector cover 203. In a state where the connector cover 203 is pulled up to the open position, the storage device 10 is inserted into the connector cover 203. Then, when the connector cover 203 is set to the close position, the storage device 10 is held between the wiring board 202 and the connector cover 203 as in FIG. 5. Terminals P arranged in the first surface 21 of the storage device 10 are connected to the lead frames 101, 102, and 103 on the wiring board 202.

A thermal interface material (TIM) 301 may be disposed to the inner surface of the connector cover 203. In that case, the second surface 22 of the storage device 10 is tightly adhered to the TIM 301.

Note that, as in FIG. 9, a connector 200′ without the TIM 301 may be used.

Note that, a hinge type connector 200 or 200′ is used in this example; however, a push-push type connector or a push-pull type connector may be used instead.

### First Embodiment

Next, as the first embodiment, a method of calculating the temperature of the storage device 10 will be described.

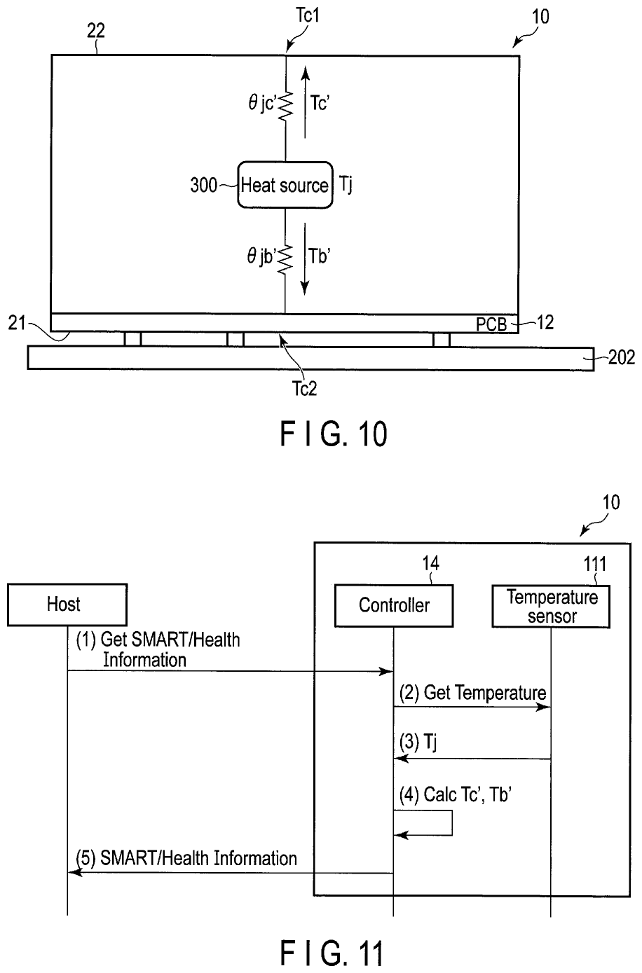

FIG. 10 illustrates a thermal resistance model used to calculate the surface temperature of the second surface 22 of the storage device 10.

The surface temperature (case temperature) Tc1 of the upper surface (second surface 22) of the storage device 10 can be calculated based on two thermal resistance models including a thermal resistance θjb′ related to the heat dissipating from the controller 14 (heat source 300 of FIG. 10) to the first surface 21 side and a thermal resistance θjc′ related to the heat dissipating from the controller 14 to the second surface 22 side.

Basically, the rout for the power consumption Pc of the controller 14 and that of the power consumption Pn of the NAND flash memory 13 which flows outside should be considered separately, but in which case, thermal calculation is problematically complicated. In order to simplify the calculation, as shown in FIG. 10, such a model is created that they are unified to the thermal resistance θjb′ and the thermal resistance θjc′ respectively at upper and lower sides. Therefore, the electric power which flows into this thermal resistance is a total power consumption Pt of the storage device.

When obtaining the surface temperature Tc of the storage device based on the internal temperature Tj of the controller 14, it is experimentally known that, even for the same total power consumption Pt, the difference in temperature between Tj and Tc also becomes greater proportionally as the power ratio becomes higher. Therefore, a two-thermal resistance model can be used to express variation of the difference in temperature by approximating the thermal resistance θjb′ and θjc′ with a linear function whose variable is the power ratio r. That is, the thermal resistance θjb′ and the thermal resistance θjc′ are not fixed values, but are of a thermal resistance model variable by power ratio r.

Thus, thermal resistance θjb′ approximates by a linear function of power ratio r (may be referred to as first linear function). Thus, thermal resistance θjb′ can be represented as follows.

θjb′=(a×r+b)[° C./W]

Here, “a” and “b” are constants derived based on the structure and the material of the storage device 10, specifically, the structure, material, and the like of the proximity of the first surface 21 side.

Thermal resistance θjc′ also can approximate by a linear function of power ratio r (second linear function). Thus, thermal resistance θjc′ can be represented as follows.

θjc′=(c×r+d)[° C./W]

Here, “c” and “d” are constants derived based on the structure and the material of the storage device 10, specifically, the structure, material, and the like of the proximity of the second surface 22 side.

As in FIGS. 8 and 9, a case where heat is dissipated from both the upper surface and the lower surface will be considered.

The heat from the controller 14 (heat source 300) dissipates not only to the wiring board 202 of the connector 200 through the first surface 21 but also to the connector cover 203 through the second surface 22. A difference between FIGS. 8 and 9 is a TIM 301, and since the heat conductivity is improved with the TIM, a ratio of heat dissipation from the upper side of the storage device 10 to the atmosphere is higher in FIG. 8 than that of FIG. 9. That is, a ratio of an upper side heat dissipation in which total power consumption Pt generated by the card (storage device 10) is dissipate from the upper side is different from a ratio of a lower side heat dissipation in which the Pt is dissipate from the lower side. The ratios are parameters determined by the heat dissipation mechanism of the host device, and a ratio of the upper side heat dissipation with respect to power will be referred to as a dissipation distribution ratio h (also referred as a distribution ratio). Power P1 distributed to the upper side and power P2 distributed to the lower side are represented as follows. The dissipation distribution ratio h is determined by the shape of the connector, the thermal radiation characteristic of the connector, or the thermal radiation characteristic of the host device.

P1=h×Pt

P2=(1−h)×Pt

In FIG. 10, an upper surface temperature Tc1 and a lower surface temperature Tc2 are represented as follows.

Tc1=Tj−h×Tc′

Tc2=Tj−(1−h)×Tb′

Here, Tj is an internal temperature of the controller 14 which is measured by the temperature sensor 111, (1−h)×Tb′ is a temperature difference between both ends of thermal resistance θjb′, which is generated by the power component P2 flowing to thermal resistance θjb′, and h×Tc′ is a temperature difference between both ends of thermal resistance θjc′, which is generated by the power component P1 flowing to thermal resistance θjc′.

Tb′ and Tc′ are represented as follows.

Tb′=θjb′×Pt

Tc′=θjc′×Pt

Here, Pt is a total power consumption of the entire storage device 10. That is, Tb indicates a temperature difference when the total power consumption all flows to the lower side, and Tc′ indicates a temperature difference when the total power consumption all flows to the upper side. They indicate temperature differences in both polar cases.

In an actual case, a balance between the upper side and the lower side differs based on the heat dissipation mechanism of the host device, and the power is distributed to the upper side at a certain distribution ratio. The dissipation distribution ratio h has the following relationship with Pt, P1, and P2.

h=P1/(P1+P2)=P1/Pt

The host device can calculate the upper side surface temperature Tc1 and lower side surface temperature Tc2, by acquiring Tj, Tb′, and Tc′ from the storage device 10.

As can be understood from the above, the host device calculates a temperature of the first surface 21 by subtracting a product of a first distribution ratio (=1−h) and Tb′ from Tj. The first distribution ratio (=1−h) is a ratio to distribute the power consumption of the storage device 10 to the lower surface (first surface) 21. Also, the host device calculates a temperature of the second surface 22 by subtracting a product of a second distribution ratio (=h) and Tc′ from Tj. The second distribution ratio (=h) is a ratio to distribute the power consumption of the storage device 10 to the upper surface (second surface) 22.

If the storage device 10 has several power states, and if a value of the total power consumption of each power state is measured beforehand, the total power consumption corresponding to a current power state of the storage device 10 may be used as the total power consumption Pt of the entire storage device 10. The total power consumption Pt may be referred to as power consumption of the storage device 10. Furthermore, the power consumption of the controller 14 and the power consumption of the NAND flash memory 13 may be measured beforehand per power state. In that case, basically, a power ratio is defined by the power consumption of the controller 14 and the power consumption of the NAND flash memory 13, which correspond to the current power state of the storage device 10. Note that a power ratio r common to each power state may be used, or a power ratio r may be calculated for each of power state beforehand.

As can be understood from the above, in the first embodiment, the temperature differences Tc′ and Tb′ are calculated based on temperature Tj of the controller 14, thermal resistance θ, and total power consumption Pt of the entire storage device 10. The thermal resistance θ is represented by the linear function of power ratio r indicative of a ratio of power consumption Pc of the controller 14 to a sum of power consumption Pc of the controller 14 and power consumption Pn of NAND flash memory 13 (where thermal resistance θ may be thermal resistance θj1′ alone, or both thermal resistance θjb′ and thermal resistance θjc′). The host device can calculate Tc1 (upper side surface temperature) and Tc2 (lower surface temperature, on the basis of the temperature Tj, the temperature differences Tc′ and Tb′, and the dissipation distribution ratio h.

The storage device 10 can read temperature Tj and temperature differences Tc′ and Tb′ such that the host device can use the temperature Tj and the temperature differences Tc′ and Tb′.

As described above, the temperature difference Tb′ is represented by a product of (1) total power consumption Pt of the entire storage device 10 and (2) the thermal resistance θjb′ related to the power dissipated from the controller 14 to the first surface 21 side, where thermal resistance θjb′ (=a×r+b) is represented by the first linear function of the power ratio r. Similarly, the temperature difference Tc′ is represented by a product of (3) total power consumption Pt of the entire storage device 10 and (4) the thermal resistance θjc′ related to the power dissipated from the controller 14 to the second surface 22 side, where thermal resistance θjc′ (=c×r+d) is represented by the second linear function of the power ratio r.

A designer of the heat dissipation mechanism of the host device knows whether or not a heat dissipation member such as TIM 301 is adhered to the connector cover 203 of the connector attached to the host device. Thus, the surface temperatures Tc1 and Tc2 can be calculated using a dissipation distribution ratio h suitable for the structure of the heat dissipation mechanism of the host device.

Thus, by reporting Tj, Tc′, and Tb′ to the host device, in either case where a connector with a TIM or a connector without a TIM is adopted in the host device, information of the surface temperatures effective for the design and evaluation of the heat dissipation mechanism of the host device can be provided with the host device. By calculating the dissipation distribution ratio h determined based on the heat dissipation mechanism of the host, the host can acquire the upper surface temperature and the lower surface temperature with respect to any dissipation distribution ratio h.

FIG. 11 illustrates a procedure of a temperature information output process.

The storage device 10 has a function to report Self-Monitoring Analysis and Reporting Technology (S.M.A.R.T.) information. In an NVM Express (NVMe) (registered trademark) specification, SMART/Health Information is defined. In the first embodiment, Tc′ and Tb′ are reported to the host device as a part of various status included in SMART/Health Information.

(1) The host device transmits a command (request) to acquire SMART/Health Information (Get SMART/Health Information) to the storage device 10.

(2) The controller 14 first executes an instruction to acquire a temperature measured by the temperature sensor 111 (Get Temperature).

(3) The controller 14 acquires the temperature measured by the temperature sensor 111 as a temperature Tj of the controller (junction temperature).

(4) The controller 14 calculates Tc′ and Tb′ based on the above-described thermal resistance model of the two thermal resistances.

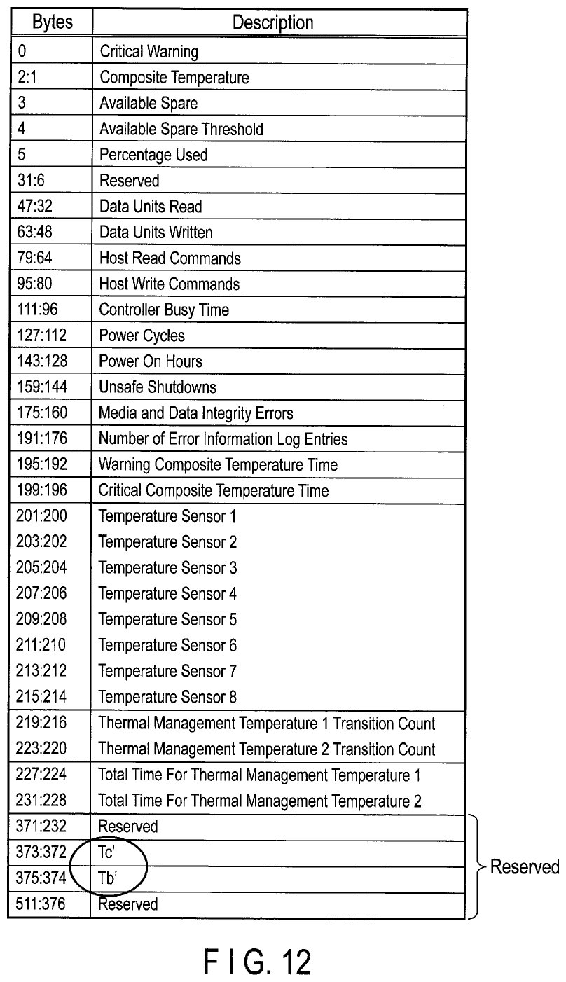

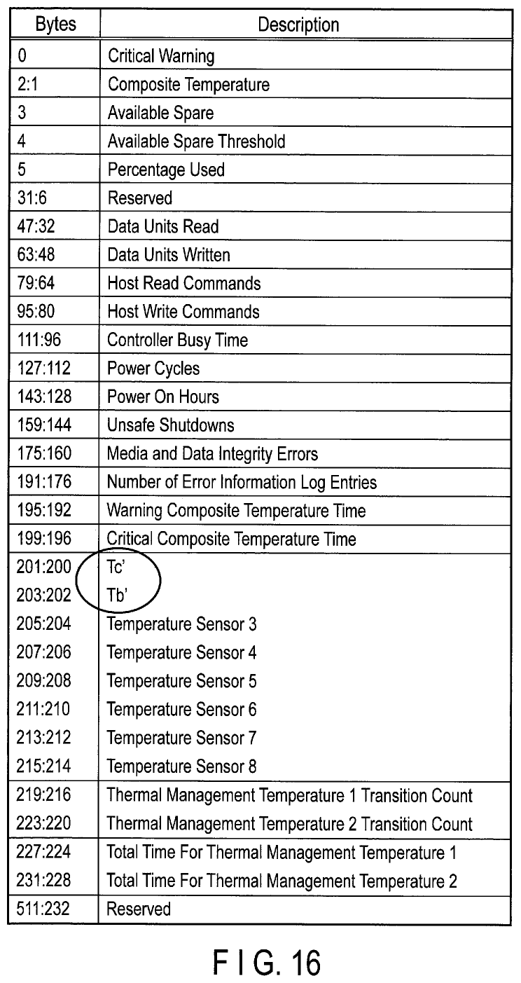

(5) SMART/Health Information includes a reserved region. The controller 14 sets Tc′ and Tb′ in a reserved region of SMART/Health Information (SMART/Health Information of FIG. 12), or sets Tc′ and Tb′ in Temperature Sensor field 1 and Temperature Sensor field 2 of SMART/Health Information (SMART/Health Information of FIG. 16), and transmits SMART/Health Information to the host device.

Note that the controller 14 may constantly monitor the temperature Tj (junction temperature) of the controller 14 by polling, and may calculate Tc′ and Tb′ from a current total power Pt when receiving the command (Get SMART/Health Information).

Two thermal threshold values set by the host controlled thermal management can be read from the following fields:

### 227:224 Total Time For Thermal Management Temperature 1 (TMT1)

### 231:228 Total Time For Thermal Management Temperature 2 (TMT2)

Furthermore, the number of times when the internal temperature Tj of the storage device 10 exceeds the above temperatures in the operation state of the device 10 will be displayed in the following fields:

### 219:216 Thermal Management Temperature 1 Transition Count

### 223:220 Thermal Management Temperature 2 Transition Count

The host can recognize the number of time when the internal temperature Tj of the controller 14 exceeds the threshold temperature TMT2 on the basis of the above counts, and can determine whether or not the storage device 10 should be further cooled on the basis of a change in the counts.

FIG. 12 illustrates an example of SMART/Health Information reported to the host device by the storage device 10.

SMART/Health Information has a size of 512 bytes. In the field corresponding to a byte position of [2:1] of SMART/Health Information, an internal temperature of the controller 14 measured by the temperature sensor 111 is recorded in degrees kelvin as a value of Composite Temperature. Any other internal temperature can be indicated.

The last 280 bytes [511:232] of SMART/Health Information is a reserved region. Thus, Tc′ and Tb′ are set in the reserved region.

For example, Tc′ may be set in [373:372], and Tb′ may be set in [375:374]. In that case, Tc′ is recorded in degrees kelvin in the field of [373:372], and Tb′ is recorded in degrees kelvin in the field of [375:374].

In general, Composite Temperature is used for host controlled thermal management. As described above, when the internal temperature Tj becomes higher than or equal to the temperature set up as TMT1, the storage device 10 itself carries out thermal throttling to lower the internal temperature. Therefore, it is desirable here that the temperature control by the host device should not overlap with the thermal throttling. That is, the temperature control by the host device should be carried out when the satisfying the relationship: the internal temperature Tj<TMT1.

Note that Tj is specific to each device, and TMT1 value is also specific to each device.

In the first embodiment, since Tj, Tc′ and Tb′ are reported to the host device, the host device can use Tj, Tc′ and Tb′ to calculate the surface temperature of the storage device 10, the surface temperature being used in the design of the heat dissipation mechanism, performance evaluation of the heat dissipation mechanism, and the like.

As can be understood from the above, in the first embodiment, Tj, Tc′ and Tb′ are set in SMART/Health Information and the SMART/Health Information including the Tj, Tc′ and Tb′ is transmitted to the host device. Therefore, in a memory system including the host device and the storage device 10 capable of being placed into the host device, the host device can calculate the surface temperature of the upper surface (second surface 22) of the storage device 10 from Tj, Tc′ and Tb′, and can use the surface temperature for the design and evaluation of the heat dissipation mechanism.

Further, the host device calculates a dissipation distribution ratio h determined by the heat dissipation mechanism of the host, and thereby, can obtain the upper surface temperature Tc1 and the lower surface temperature Tc2 which correspond to any dissipation distribution ratio h.

Thus, for example, the host device also can observe both the transition of the internal temperature Tj and the transition of the upper surface temperature difference Tc′ and the lower surface temperature difference Tb′ while executing the read/write accesses with respect to the storage device 10, and can easily evaluate the performance of the heat dissipation mechanism of the host device by calculating the upper surface temperature Tc1 and the lower surface temperature Tc2.

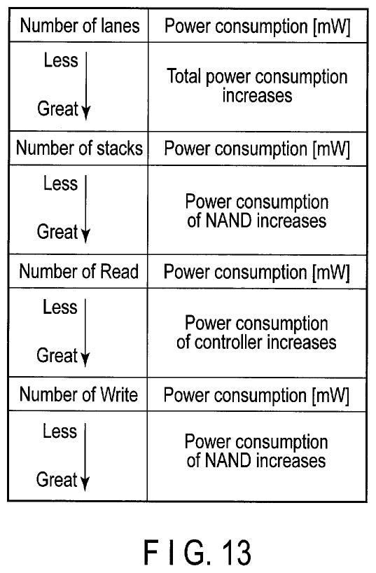

FIG. 13 illustrates the number of lanes, the number of stacks, a relationship between the power consumption of the controller 14 and the power consumption of the NAND flash memory 13 in the read operation, and a relationship between the power consumption of the controller 14 and the power consumption of the NAND flash memory 13 in the write operation.

The total power Pt and the power ratio r between the controller 14 and the flash memory 13 are determined based on these parameters (that is, the number of lanes, the number of stacks, a relationship between the power consumption of the controller 14 and the power consumption of the NAND flash memory 13 in the read operation, and a relationship between the power consumption of the controller 14 and the power consumption of the NAND flash memory 13 in the write operation), and more accurate surface temperature calculation can be performed if these parameters are taken into consideration. Since the parameters change actively, the total power consumption Pt and the power ratio r change in real time based on the operation state of the storage device 10. Note that the host device can maintain the surface temperature constant by creating a certain steady operation state where the heating of the storage device 10 and the heat dissipation of the host device are balanced. There is a time gap between a time when the operation state becomes constant and a time when the surface temperature becomes constant, and thus, the time gap must be considered.

Basically, the power ratio can be calculated based on the number of lanes of PCIe used in the data transfer, the number of stacks of the nonvolatile memories, and power state of the storage device 10.

Based on the increase of the number of lanes of PCIe bus included in the storage device 10, the data transfer rate between the host device and the storage device 10 increases. Thus, based on the increase of the number of lanes included in the storage device 10, power consumption Pc [mW] of the controller 14 and power consumption Pn [mW] of the NAND flash memory 13 both tend to increase. As a result, the total power consumption Pt [mW] of the storage device 10 increases.

The number of stacks of the NAND flash memory 13 indicates the number of NAND flash memory chips stacked one after another in the NAND flash memory 13. As the number of NAND flash memory chips included in the NAND flash memory 13 increases, the power consumption Pn of the NAND flash memory 13 tends to increase.

The power consumption Pc of the controller 14 differs in the read operation and the write operation with respect to the NAND flash memory 13. Similarly, the power consumption Pn of the NAND flash memory 13 differs in the read operation and the write operation with respect to the NAND flash memory 13. The power consumption Pc of the controller 14 in the read operation tends to be greater than the power consumption Pc of the controller 14 in the write operation. This is because, for one reason, a decode process to correct an error in the data read from the NAND flash memory 13 is required in the read operation by the controller 14.

On the other hand, the power consumption Pn of the NAND flash memory 13 in the write operation tends to be greater than the power consumption Pn of the NAND flash memory 13 in the read operation.

Thus, the power ratio in the read operation is different from the power ratio in the write operation.

As explained above, since the power ratio in the read operation differs from the power ratio in the write operation, the power ratio r used in calculation of Tc′ and Tb′ is calculated based on (i) the number of read operations and the number of write operations executed in a certain period of time (for example, during latest one second), (ii) power ratio in the read operation, and (iii) power ratio in the write operation.

An example of calculation in a case where both read operations and write operations are executed will be explained. In a state in which memory access is performed, power ratio r will be represented as follows where a power ratio in the read operation is given rr, power ratio in the write operation is given rw, the number of read operations performed in the certain period of time is given cr, and the number of write operations performed in the certain period of time is given cw.

r=rr×cr/(cr+cw)+rw×cw/(cr+cw)

In the state where the NAND flash memory 13 is not accessed, it may be considered that the power ratio r≈1 and the power consumption Pn≈0, and the power consumption Pc of the controller 14 at that time takes a small value, which can be experimentally obtained in advance.

Furthermore, the total power consumption Pt of the entire storage device 10 is calculated based on the power consumption of the controller 14 in the read operation, power consumption of the NAND flash memory 13 in the read operation, power consumption of the controller 14 in the write operation, power consumption of the NAND flash memory 13 in the write operation, the number of read operations executed in a certain period of time, and the number of write operations executed in the certain period of time.

The total power consumption Pt will be represented as follows where

rcp: Power consumption of controller 14 when read operation is executed for n times in the certain period of time,

rnp: Power consumption of NAND flash memory 13 when read operation is executed for n times in the certain period of time,

wcp: Power consumption of controller 14 when write operation is executed for n times in the certain period of time, and

wnp: Power consumption of NAND flash memory 13 when write operation is executed for n times in the certain period of time.

Pt=(rcp+rnp)×cr/n+(wcp+wnp)×cw/n

The number n may be considered as an upper limit number of read/write operations executable in a certain period of time, and while the upper limit number of read operations may be different from that of write operations, the same upper limit number n is adopted in this example for simplification. Thus, a relationship of cr≤n, cw≤n, cr+cw≤n is established.

A transition of power states of the storage device 10 can be controlled using cr and cw. That is, if cr and cw are close to maximum number (i.e., the upper limit number), the storage device 10 operates in the maximum performance power state, and if they are minimum, the storage device 10 operates in the power state with lowest power. Note that there is a dormant mode power state where a read/write operation is not performed. Note that values preliminarily measured per power state may be used as values of rcp, rnp, wcp, and wnp.

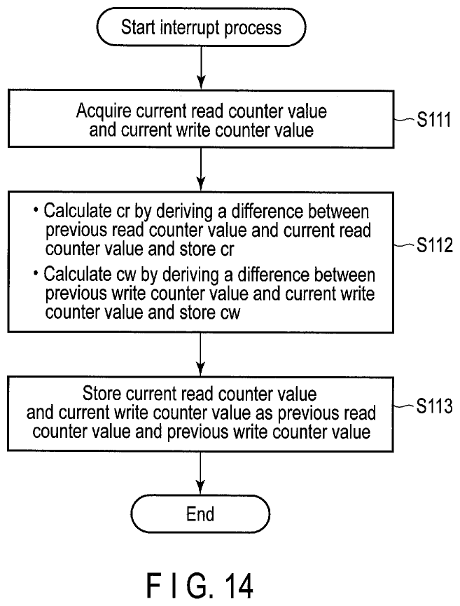

The flowchart of FIG. 14 shows the procedure of the process of calculating cr, which indicates the number read operations executed within a predetermined period, and cw, which indicates the number of write operations executed within the predetermined period.

Here, it is assumed that a read counter and a write counter are provided in the controller 14. The read counter and the write counter count the number of read operations (the number of times of read operations) and the number of write operations (the number of times of write operations), respectively. CPU 56 of the controller 14 executes an interrupt process indicated in the flowchart of FIG. 14 every predetermined period, for example, every time a timer interrupt is generated per second. In the interrupt process, CPU 56 initially acquires a current read counter value and a current write counter value from the read counter and the write counter, respectively (step S111). CPU 56 calculates cr by deriving a difference between a previous read counter value and the current read counter value, and stores the calculated cr in a memory region of the controller 14 (step S112). Here, the process is executed in consideration of the case where the counters overflow to return to zero. In step S112, CPU 56 further calculates cw by deriving a difference between a previous write counter value and the current write counter value, and stores the calculated cw in the memory region.

Then, CPU 56 stores the current read counter value and the current write counter value acquired in step S111 into the memory region (step S113). The current read counter value is stored as the previous read counter value for the next interrupt process, and the current write counter value is also stored as the previous write counter value for the next interrupt process.

In the case of one second loop in which the interrupt process (loop) is executed for each one second, the cr and cw values immediately before the completion of a loop are each calculated based on a total value at a maximum of two seconds before. If the accuracy is low by one second loop, it can be improved by executing the loop, for example, for every 100 ms. In this case, it is necessary to reserve a region equivalent to ten of the regions where the values are temporarily stored in Step 112. In Step 112, there are ten read numbers and ten write numbers calculated for every 100 ms, and when the 10 read numbers for every 100 ms are totaled, the read number cr per one second immediately before can be obtained, and when the 10 write numbers for every 100 ms are totaled, the write number cw per one second immediately before can be obtained.

When evaluating the heat dissipation mechanism of the host device, the host device needs to measure the surface temperature in the state where the surface temperature of the case 11 of the storage device 10 becomes the maximum. Note that when the storage device 10 operates at the maximum performance, the heat generation amount of the storage device 10 becomes the maximum. When the host device reads the surface temperature of the storage device 10 after continuous read operations (cr≈n) or continuous write operations (cw≈n) are carried out for the predetermined period or longer (e.g., one second or longer), the surface temperature can be measured in the state where the surface temperature of the case 11 of the storage device 10 is at the maximum. When the read operations or the write operations are continuously carried out for longer than the predetermined period, the surface temperature which has converged to a steady state can be read.

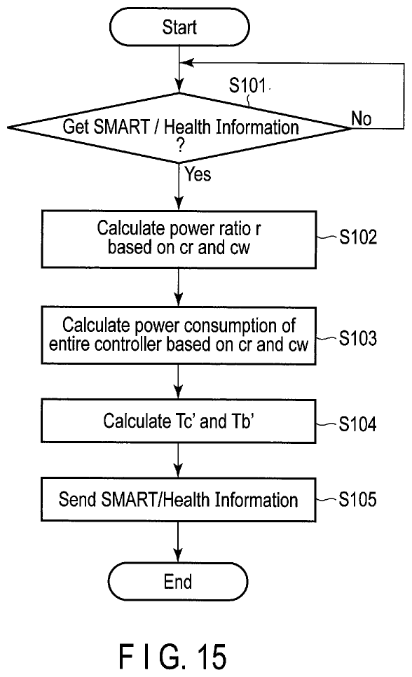

FIG. 15 is a flowchart illustrating an example of a process to calculate the power ratio and the total power consumption based on the number of read operations and the number of write operations.

The storage device 10 is connectable to the host in accordance with the NVMe specification.

If Get SMART/Health Information is received from the host device (YES in step S101), CPU 56 calculates power ratio r based on the number cr of read operations and the number cw of write operations executed in a certain period of time (in this example, the latest one second) (step S102). CPU 56 calculates the total power consumption Pt of the entire storage device 10 based on the number cr of read operations and the number cw of the write operations executed in the latest one second (step S103). CPU 56 calculates Tc′ and Tb′ based on the internal temperature Tj of the controller 14 (i.e., measured temperature of the controller 14), the thermal resistance θjb′ represented by the first linear function of the power ratio r, the thermal resistance θjc′ represented by the second linear function of the power ratio r, and the total power consumption Pt (step S104).

Then, CPU 56 sets the internal temperature Tj as a value of Composite Temperature of SMART/Health Information. Further, CPU 56 sets Tc′ and Tb′ in the reserved region of SMART/Health Information (SMART/Health Information of FIG. 12), or sets Tc′ and Tb′ in Temperature Sensor field 1 and Temperature Sensor field 2 of SMART/Health Information (SMART/Health Information of FIG. 16). Then, CPU 56 transmits SMART/Health Information in which the temperature Tj of the controller 14 is set as the value of Composite Temperature and Tc′ and Tb′ are set in the reserved region or Temperature Sensor fields to the host device (step S105).

The host device calculates surface temperatures Tc1 and Tc2 using (i) the dissipation distribution ratio h determined by the heat dissipation mechanism of the host device, and (ii) Tj, Tc′, and Tb′ read from the storage device 10. In that case, the host device reads Tj set in Composite Temperature of SMART/Health Information sent from the storage device 10, and Tc′ and Tb set in SMART/Health Information, and calculates the temperature of the first surface 21 by subtracting a product of the first distribution ratio (=l-h) and Tb′ from Tj, and the temperature of the second surface 22 by subtracting a product of the second distribution ratio (=h) and Tc′ from Tj. The first distribution ratio (=l−h) is a ratio to distribute the power consumption of the storage device 10 to the lower surface (first surface) 21, and the second distribution ratio (=h) is a ration to distribute the power consumption of the storage device 10 to the upper surface (second surface) 22.

As explained above, in the first embodiment, a temperature itself increased by the heat from the controller 14 of the storage device 10 is not reported to the host device, but instead, based on a thermal resistance model, information indicative of a temperature difference between the upper surface (second surface 22) and the controller 14 and a temperature difference between the lower surface (first surface 21) and the controller 14, which are calculated in consideration of the temperature of the controller 14 and the temperature of the NAND flash memory 13, is transmitted to the host device. In other words, in response to a request to acquire a temperature received from the host device, the controller 14 transmits, to the host device, temperature data indicative of temperature Tj measured by the temperature sensor 111 in the controller 14, temperature data indicative of a temperature difference Tb′ between the temperature Tj and a temperature of the first surface 21, and temperature data indicative of a temperature difference Tc′ between the temperature Tj and a temperature of the second surface 22, using at least one of signal terminals p.

In that case, the controller 14 calculates temperature data indicative of the temperature difference Tb′ and temperature data indicative of the temperature difference Tc′ based on a thermal resistance model (thermal resistance model correlated with the power consumption (total power consumption) of the storage device 10) related to the heat dissipating from the controller 14 to the outside of the storage device 10. The temperature data indicative of the temperature difference Tb′ is represented by a product of thermal resistance θjb′ between the controller 14 and the lower surface (first surface 21) and the power consumption (total power consumption) Pt of the storage device 10, that is, θjb′×Pt, and the temperature data indicative of the temperature difference Tc′ is represented by a product of thermal resistance θjc′ between the controller 14 and the upper surface (second surface 22) and power consumption (total power consumption) Pt of the storage device 10, that is, θjc′×Pt. Thus, the host device can correctly evaluate a heat dissipation performance of the host device using the temperature Tj, temperature difference Tb′, and temperature difference Tc′.

With the above-described structure, the storage device 10 can report information used to calculate the surface temperatures of the upper surface and the lower surface of the storage device 10 used by the host device for optimization of the heat dissipation mechanism thereof using the temperature sensor to detect the temperatures of the controller 14 without providing a temperature sensor in the proximity of the upper surface (second surface 22) of the storage device 10. Furthermore, the host device can recognize the surface temperature of the upper surface of the storage device 10. Furthermore, the host device can perform a host controlled thermal management to change the power state of the storage device 10 based on a relationship between the junction temperature and the surface temperature of the storage device 10.

The surface temperature calculated indicates a surface temperature of the position on the second surface 22 above the controller 14 and a surface temperature of a position on the first surface 21 below the controller 14.

Furthermore, in the first embodiment, the thermal resistance is represented by a linear function of the power ratio r indicative of a ratio of the power consumption of the controller 14 to a sum of the power consumption of the controller 14 and the power consumption of the NAND flash memory 13. Thus, the surface temperature of the position on the second surface 22 above the controller 14 can be calculated from the operation state and the internal temperature of the controller 14.

Furthermore, in the first embodiment, the controller 14 calculates the upper side temperature difference Tc′ and the lower side temperature difference Tb′ from the internal temperature Tj, power ratio r, and total power consumption Pt, and transmits Tj, Tc′ and Tb′ to the host device. The host device calculates, from the internal temperature Tj, upper side temperature difference Tc′, and lower side temperature difference Tb′ read from the controller 14, the upper side surface temperature Tc1 and the lower side surface temperature Tc2 using the dissipation distribution ratio h determined by the heat dissipation mechanism of the host, and obtain information of temperature effective for the optimization of the heat dissipation mechanism of the host device.

Note that, in the first embodiment, the NAND flash memory is used as an example of the nonvolatile memory. The first embodiment, however, can be applied to various nonvolatile memories such as a magnetoresistive random access memory (MRAM), phase change random access memory (PRAM), resistive random access memory (ReRAM), and ferroelectric random access memory (FeRAM).

### Variation of First Embodiment

As described above, Tc′ and Tb′ can be reported to the host device as a part of various status included in SMART/Health Information.

FIG. 16 illustrates an example of SMART/Health Information in which Tc′ and Tb′ are set to a field in SMART/Health Information other than the reserved region. In SMART/Health Information, field [201:200], field [203:202], field [205:204], field [207:206], field [209:208], field [211:210], field [213:212], and field [215:214] are used as Temperature Sensor 1 field, Temperature Sensor 2 field, Temperature Sensor 3 field, Temperature Sensor 4 field, Temperature Sensor 5 field, Temperature Sensor 6 field, Temperature Sensor 7 field, and Temperature Sensor 8 field. Each of the eight fields is used to report the temperature of the NVMe device to the host device. The temperature to be reported may be measured in any method. Thus, Tc′ and Tb′ may be set in two fields in the eight Temperature Sensor fields.

FIG. 16 illustrates a case where Tc′ and Tb′ are set to first two fields in the eight Temperature Sensor fields, that is, [201:200] and [203:202]. The controller 14 can transmit SMART/Health Information in which the temperature Tj of the controller 14 is set as a value of Composite Temperature and Tc′ and Tb′ are set in first two fields of the eight Temperature Sensor fields to the host device.

### Second Embodiment

Next, as the second embodiment, a method of calculating the temperature of the upper surface of the storage device 10 directly, thereby making it unnecessary to perform the calculation to obtain the surface temperature of the host device at all will be described. This method utilizes such a mechanism that the dissipation distribution ratio h approximates to a value near zero because the most of the heat dissipates through the lower surface to the outside.

In the second embodiment, a temperature Tc2 of an upper surface (second surface 22) in a case where the heat in a storage device 10 mainly dissipates to the outside thereof through a lower surface (first surface 21) (h0), and a temperature Tc1 of the upper surface (second surface 22) in a case where the heat in the storage device 10 dissipates to the outside thereof through not only the lower surface (first surface 21) but also the upper surface (second surface 22) (0<h<<1) are reported to the host device as a temperature Tc of the upper surface (second surface 22). Temperatures Tc1 and Tc2 are calculated based on a thermal resistance model related to the heat dissipating from the controller 14 to the outside of the storage device 10 (thermal resistance model correlated with the power consumption (total power consumption) of the storage device 10).

The hardware structure of the storage device 10 of the second embodiment (shape, pad arrangement, circuit structure, and the like) is the same as that of the first embodiment. In the following description, mainly, differences from the first embodiment will be explained.

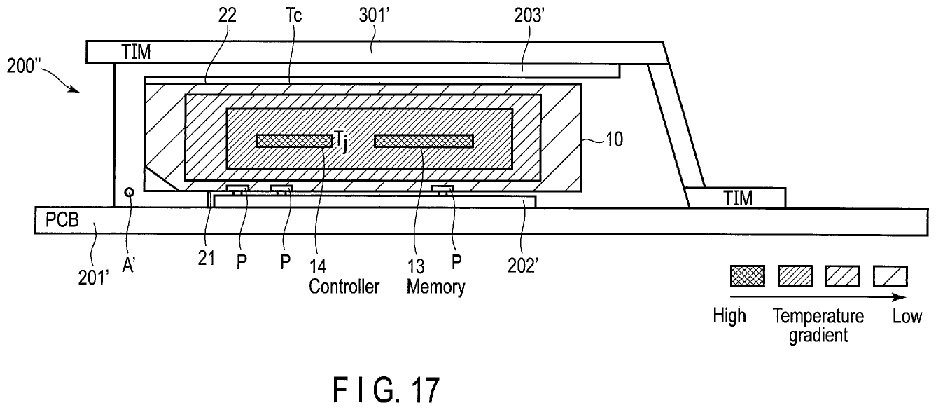

Initially, a thermal model of the second embodiment will be explained with reference to FIG. 17. FIG. 17 illustrates that the storage device 10 is placed into a connector 200″ in the host device.

The connector 200″ may include a wiring board 202′ and a connector cover 203′. The connector cover 203′ may be attached to a system board (printed circuit board PCB) 201′ of the host device to rotate about axis A′ which functions as a hinge portion between an open position where the wiring board 202′ is exposed and a close position where the wiring board 202′ is covered with the connector cover 203′. While the connector cover 203′ is pulled up to the open position, the storage device 10 is inserted to the connector cover 203′. Then, when the connector cover 203′ is closed in the close position, the storage device 10 is placed into the connector 200″ as in FIG. 15.

Heat sources in the storage device 10 will be the controller 14 and the NAND flash memory 13. Based on the operation mode of the storage device 10, the heat generation ratio between the controller 14 and the NAND flash memory 13 changes, and thus, a parameter of a ratio between power consumption Pc of the controller 14 and power consumption Pn of the NAND flash memory 13 (power ratio r) is used. The power ratio r is, as explained in the first embodiment, a ratio of power consumption Pc of the controller 14 to total power consumption Pt of the storage device 10 (Pt=Pc+Pn), that is, Pc/(Pc+Pn). Similarly to the first embodiment, power ratio r in the state in which memory access is performed is obtained on the basis of the number of read operations and the number of write operations.

As with the first embodiment, the controller 14 includes the temperature sensor 111 to measure the internal temperature Tj of the controller 14. The controller 14 calculates, based on a thermal resistance model related to the heat dissipating from the controller 14 to the outside of the storage device 10, a temperature Tc2 of the upper surface (second surface 22) in a case where the heat mainly dissipates from the controller 14 to the outside of the lower surface (first surface 21) and a temperature Tc1 of the upper surface (second surface 22) in a case where the heat dissipates from the controller 14 to both the outside of the lower surface (first surface 21) and the outside of the upper surface (second surface 22) as a temperature Tc of the upper surface (second surface 22). Here, the temperature Tc is a surface temperature of a position on the second surface 22 above (immediately above, for example) the controller 14.

In the thin card-like shaped storage device 10, it is considered that there is a temperature gradient in which the temperature in the proximity of the center thereof becomes highest, and the temperature gradually decreases to the outer periphery. In FIG. 17, the temperature gradient in the storage device 10 is represented by differences of density of hatchings. The temperature is highest in a part of cross-hatching, second highest in a part of high density single hatching surrounding the part of cross-hatching, third in a part of middle density single hatching surrounding the part of high density single hatching, and lowest in a part of low density single hatching surrounding the part of middle density single hatching. Note that, in this example, the temperature gradient in the storage device 10 is illustrated simply with four temperature levels corresponding four different hatchings; however, the temperature in the storage device 10 actually changes continuously. Here, it is assumed that the heat mainly dissipates from the lower surface to the outside, which means that there is such an advantage of cooling the storage device 10 and lowering the temperature of the upper surface.

The storage device 10 is connected to PCB 201′ of the host device through the connector 200″. Many terminals P are provided with the first surface 21 of the storage device 10. The terminals P are electrically connected to PCB 201′ through a contact (lead frame). The heat dissipation effect of the heat conductivity of the contact is sufficiently high. Note that the lead frames of the connector are located in the board 202′, but they are not illustrated here, and instead, only the contact portions (point contacts) with the terminals of the storage device 10 are shown.

There may be a gap between the connector cover 203′ and the upper surface (second surface 22) of the storage device 10. In that case, a part of the upper surface (second surface 22) of the storage device 10 contacts the connector cover 203′ while most part of the upper surface (second surface 22) contacts an air layer of poor heat conductivity. That is, while the lower surface (first surface 21) is electrically connected to PCB 201′ through the contact (lead frame) of high heat conductivity, the upper surface (second surface 22) contacts the air layer of poor heat conductivity, and thus, it is considered that the greater amount of heat is dissipated from the lower surface (first surface 21) of the storage device 10. That is, the greater amount of heat dissipates to the outside of the lower surface (first surface 21) of the storage device 10.

Thus, even if TIM 301′ is disposed on the connector 200″ as in FIG. 17, the dissipation from the lower surface is dominant and the dissipation from TIM 301′ is considered auxiliary.

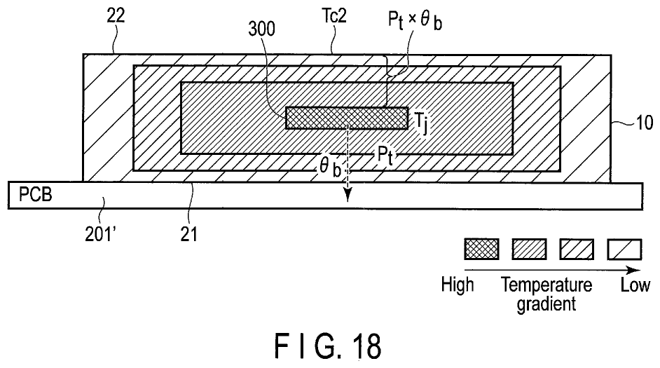

FIG. 18 is a diagram illustrating a dissipation model corresponding to a connector without TIM. In FIG. 18, a dissipation model is illustrated in a simplified manner in which the connector 200″ is omitted.

If the upper side of the upper surface (second surface 22) of the storage device 10 is air as in a case where a large gap is between the upper surface (second surface 22) of the storage device 10 and the connector cover 203′, the heat from the controller 14 (heat source 300 of FIG. 18) mainly dissipates to PCB 201′ through the lower surface (first surface 21) of the storage device 10, and thus, also the surface temperature Tc of the upper surface (second surface 22) lowers. In the second embodiment, the surface temperature Tc of the upper surface (second surface 22) in a case where there is no TIM, that is, the surface temperature Tc of the upper surface (second surface 22) in a case where the heat mainly dissipates from the lower surface (first surface 21) to the outside of the storage device 10 will be defined as Tc2.

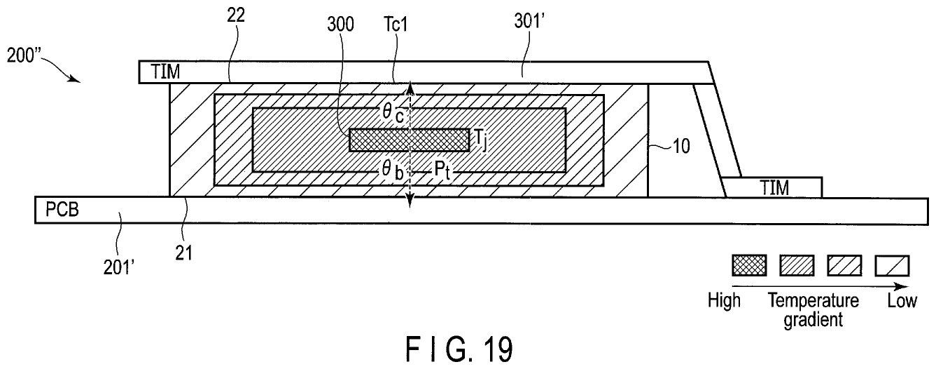

FIG. 19 is a diagram illustrating a heat dissipation model corresponding to a connector with TIM. In FIG. 19, a dissipation model is illustrated in a simplified manner in which the connector 200″ is omitted.

If a TIM 301′ of high heat conductivity is mounted on the upper surface (second surface 22), the surface temperature Tc of the upper surface (second surface 22) further decreases by the heat dissipation effect from the upper surface (second surface 22). For example, the TIM 301′ may be disposed on the connector cover 203′ contacting the upper surface (second surface 22) such that a gap scarcely exists between the upper surface (second surface 22) of the storage device 10 and the connector cover 203′, for example. The TIM 301′ dissipates the heat of the connector 200″ to the PCB 201′. The TIM 301′ may be realized by a heat conductive sheet adhered to both the connector cover 203′ and the PCB 201′. Or, as in FIG. 8, a connector structure in which the TIM 301′ of high heat conductivity is disposed in the inner surface of the connector cover 203′.

In the second embodiment, the surface temperature Tc of the upper surface (second surface 22) in a case where there is a TIM, that is, in a case where the heat from the controller 14 (heat source 300) not only dissipates from the lower surface (first surface 21) to the outside of the storage device 10, but also dissipates from the upper surface (second surface 22) to the outside of the storage device 10, will be defined as Tc1.

Tc1 in a case where there is TIM can be represented by the following formula:

Tc1=Tj−(1−h)×Pt×θb′−h×Pt×θc′

Tj: Internal temperature measured by the temperature sensor 111 in the controller 14;

Pt: total power consumption of storage device 10 in a predetermined period (for example, one second immediately before);

θb′: a thermal resistance component which generates a temperature difference between the temperature sensor 111 and the lower surface (first surface 21) of the storage device 10; and

θc′: a thermal resistance component which generates a temperature difference between the temperature sensor 111 and the upper surface (second surface 22) of the storage device 10.

The first half of the formula Tj−(1−h)×Pt×θb′ represents the temperature difference between the temperature sensor 111 and the lower surface. The last half of the formula h×Pt×θc′ represents the temperature difference between the temperature sensor 111 and the upper surface when with TIM. The value h is close to zero, but if the maximum value for h, that is, hm, is assumed, the formula can be simplified as θb=(1−hm)×θb′ and θc=hm×θc′.

Tc1=Tj−Pt×θb−Pt×θc

Tc2 in a case where there is not TIM is for the case where θc=0. In this case, an approximation of (1−hm)≈1, θc=0, which gives the following:

Tc2=Tj−Pt×θb

Thus, the temperature of PCB 201′ of the host device becomes Tc2. Or it can be also expressed as

Tc1=Tc2−Pt×θc.

As described in the first embodiment, the thermal resistances θb and θc can be expressed by linear functions of the power ratio r, but the factors of the linear functions are different from each other.

A case where an actual surface temperature Tc of the storage device 10 placed into the host device is measured by a temperature sensor is considered, it will be understood that the surface temperature Tc actually measured therein is within a range of Tc1≤Tc≤Tc2 (may be referred to as a temperature varying range). The controller 14 reports two temperatures Tc1 and Tc2 as the surface temperature (case temperature) Tc of the upper surface to the host device to report that the actual Tc is between the temperature Tc1 and the temperature Tc2 (temperature varying range) to the host device. A designer of the heat dissipation mechanism of the host device knows that the actual Tc is between the temperatures Tc1 and Tc2 (temperature varying range), and thus, may evaluate the performance of the heat dissipation mechanism of the host device using the temperature varying range defined by two values (Tc1 and Tc2) reported by the storage device 10. Or, the designer of the heat dissipation mechanism of the host device knows whether or not the TIM 301′ of high heat conductivity is mounted on the upper surface (second surface 22), and thus, may select one of Tc1 or Tc2 as the surface temperature suitable for the structure of the heat dissipation mechanism of the host device, and may evaluate the performance of the heat dissipation mechanism of the host device by using the selected surface temperature. Or, the host device may refer to a ratio of the heat dissipating to the lower surface to the heat dissipating to the upper surface to estimate that the actual surface temperature Tc is a median value of Tc1 and Tc2 derived from the ratio.

Note that a single surface temperature Tc1 may be reported to the host device (in that case, Tc2 may be 0). In that case, an actual Tc may be designated as a value within a range of Tc1 to Tc1±α %. Note that α % is a parameter to indicate a variation of Tc, and is, for example, a % may be 20%. Furthermore, only a single surface temperature Tc2 may be reported to the host device (in that case, Tc1 may be 0).

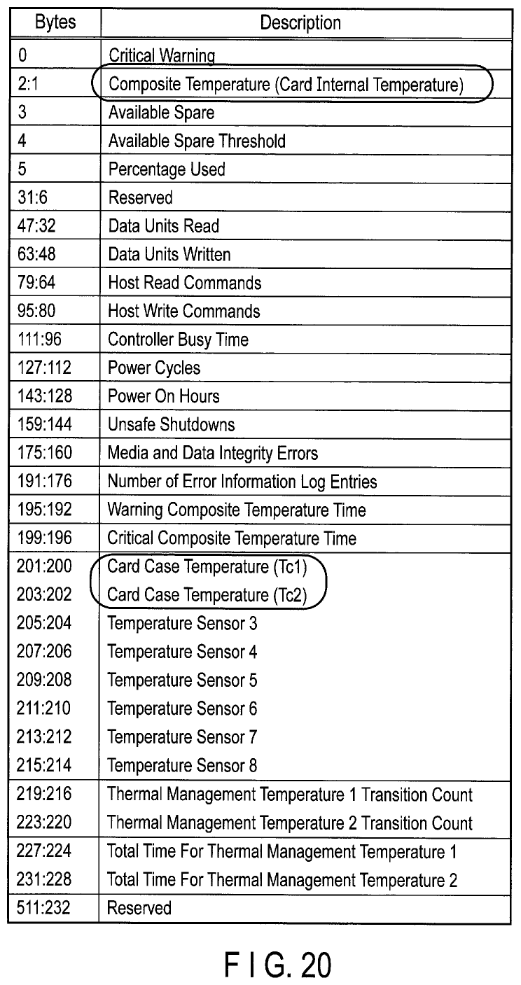

FIG. 20 illustrates an example of SMART/Health Information to be reported to the host device by the storage device 10.

In the second embodiment, the controller 14 generates SMART/Health Information including Tj, Tc1, and Tc2 and transmits the SMART/Health Information to the host device.

In the field corresponding to a byte position of [2:1] of SMART/Health Information, an internal temperature (card internal temperature) of a certain portion in the storage device 10 is recorded in degrees kelvin as a value of Composite Temperature. The internal temperature (card internal temperature) may be Tj, but it should not necessarily be Tj because host does not use Tj to obtain Tc. For example, it may indicate the internal temperature of the NAND flash memory 13.

A card case temperature (Tc1) is recorded in degrees kelvin in top field [201:200] of eight Temperature Sensor fields. A card case temperature (Tc2) is recorded in degrees kelvin in second field [203:202] of eight Temperature Sensor fields.

Thus, two temperature estimation values, that is, temperature data indicative of Tc1 and temperature data indicative of Tc2 are transmitted to the host device to report that the value of actual Tc is within a range of Tc1 to Tc2 to the host device. The host device may select one of Tc1 and Tc2 as the surface temperature of the upper surface corresponding to the structure of the connector 200″ of the host device (with/without TIM). Note that a single surface temperature Tc1 may be reported to the host device. If Tc2 is not reported, 0h is set to field [203:202].

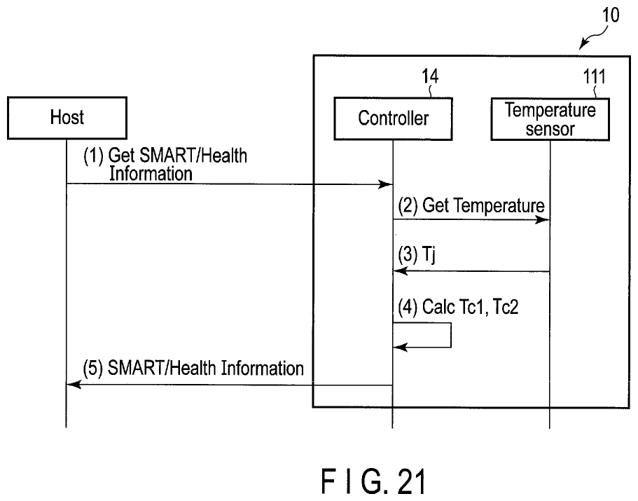

FIG. 21 is a sequence diagram illustrating a procedure of a temperature information output process executed by the storage device 10.

(1) The host device transmits a command (request) to acquire SMART/Health Information (Get SMART/Health Information) to the storage device 10.

(2) The controller 14 acquires the temperature measured by the temperature sensor 111 as the internal temperature of the controller (Get Temperature).

(3) The controller 14 adjusts the measured internal temperature to the estimated highest internal temperature Tj. This calculation is required if the temperature sensor 111 is not located around the maximum temperature area of the controller 14.

(4) The controller 14 calculates power ratio r depends on operation modes, the number of times of read operations cr and the number of times of write operations cw. The controller 14 calculates total power consumption Pt in a certain period of time from the number of read operations cr, the number of write operations cw and power ratio r. The controller 14 calculates thermal resistance θb and thermal resistance θc from power ratio r on the basis of two-thermal resistance model. The controller 14 calculates Tc1 and Tb2 from Tj, total power consumption Pt, thermal resistance θb and thermal resistance θc.

Tc2 is calculated by subtracting a product of thermal resistance θb between the controller 14 and the first surface 21 and power consumption Pt of the storage device 10 mainly dissipated from the first surface 21 (Pt×θb) from Tj. Tc1 is calculated by subtracting surface temperature Pt×θc decreasing by being dissipated from the second surface 22 from Tc2.

Tc2=Tj−Pt×θb

Tc1=Tc2−Pt×θc

The power consumption Pt of the storage device 10 in a certain period of time (for example, latest one second) depends on the operation state (read operation and write operation, etc.) of the storage device 10, and is represented as a sum of the power consumption Pc of the controller 14 and the power consumption Pn of the NAND flash memory 13. Pc and Pn are calculated from the number of times of read operations cr within the predetermined period and the number of times of write operations cw within the predetermined period respectively, and θb and θc are represented by linear functions of the power ratio r. The power ratio r while accessing the flash memory can be calculated out from the number of times of read operations cr within the predetermined period and the number of times of write operations cw within the predetermined time.

(5) The controller 14 sets a certain internal temperature of the storage device 10 as Composite temperature (card internal temperature), sets Tc1 and Tc2 as card case temperatures of the storage device 10, and transmits to the host device the SMART/Health Information including data indicative of the internal temperature of the storage device 10, data indicative of Tc1, and data indicative of Tc2.

Note that the controller 14 constantly monitors the internal temperature Tj of the controller 14 by polling for the purpose of the thermal throttling. With respect to Tc1 and Tc2, when receiving the command (Get SMART/Health Information), the controller 14 may calculate the Tc1 and Tc2 from Tj and total power consumption Pt.

How to obtain cr and cw is similar to that illustrated in the flowchart of FIG. 14, and how to obtain the power ratio r and total power consumption Pt are similar to those of the first embodiment.

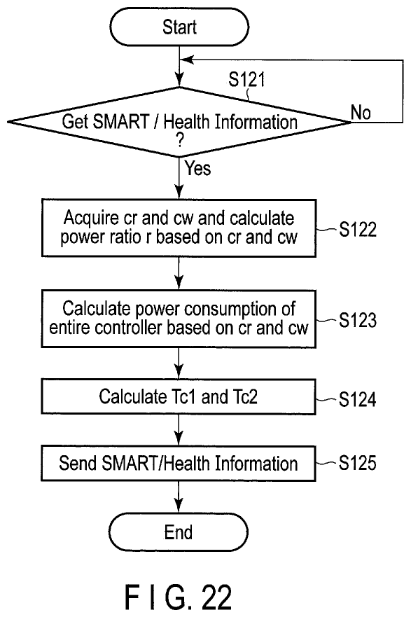

As showed in flowchart of FIG. 22, when Get SMART/Health Information is received from the host device (YES in step S121), CPU 56 acquires the number cr of read operations and the number cw of write operations executed in a certain period of time (e.g., latest one second) from the memory region, and calculates a power ratio r based on cr and cw (step S122). CPU 56 calculates the total power consumption Pt of the entire storage device 10 based on the number cr of read operations and the number cw of the write operations executed in the certain period of time (step S123). CPU 56 calculates Tc1 and Tc2 based on the temperature Tj of the controller 14, thermal resistance θb which is a linear function the power ratio r, thermal resistance θc which is a linear function of the power ratio r, and power consumption Pt of the storage device 10 (step S124).

Then, CPU 56 sets a certain internal temperature of the storage device 10 as a value of Composite Temperature, sets Tc1 and Tc2 in the Temperature sensor 1 and the Temperature sensor 1 as a value of a temperature of the second surface 22 (case temperature), and transmits SMART/Health Information in which the internal temperature, Tc1 and Tc2 are set to the host device (step S125).

As explained above, in the second embodiment, the controller 14 transmits, in response to a request to acquire a temperature received from the host device, data indicative of the internal temperature of the storage device 10, data indicative of the temperature Tc2 of the upper surface (second surface 22) in a case where the heat in the storage device 10 dissipates to the outside thereof through the lower surface (first surface 21), and data indicative of the temperature Tc1 of the upper surface (second surface 22) in a case where the heat in the storage device 10 dissipates to the outside thereof through both the lower surface (first surface 21) and the supper surface (second surface 22) to the host device, using at least one of the signal terminals p. Data indicative of the internal temperature, data indicative of Tc1, and data indicative of Tc2 can be reported to the host device in SMART/Health Information. The values of the data satisfy the following relationships.

The data indicative of Tc1 is smaller than the data indicative of Tc2 (Tc1<Tc2). The data indicative of Tc1 and the data indicative of Tc2 are greater than data indicative of an ambient temperature (Ta) of the storage device 10 (Tc1>ta, Tc2>Ta). A relationship of Tc1>Ta and Tc2>Ta is a condition necessary to dissipate the heat in the storage device 10 to the outside. In the memory system including the host device and the storage device 10, since the storage device 10 operates while being placed into the host device, the ambient temperature (Ta) of the storage device 10 is a peripheral environment temperature of the storage device 10. For example, in a state where the storage device 10 is placed into a connector in the host device, a temperature of air surrounding the storage device 10 placed into the connector, or temperature of air surrounding the connector, or the like will be the ambient temperature (Ta) of the storage device 10.

Based on whether or not the data indicative of Tj, data indicative of Tc1, and data indicative of Tc2 satisfy the conditions above (Tc1<Tc2, Tc1>Ta, and Tc2>Ta), effectiveness of data of the temperatures (Tc1, Tc2, and Tj) sent to the host device in SMART/Health Information may be checked. For example, the host device may acquire SMART/Health Information from the storage device 10 while executing a read/write access with respect to the storage device 10 placed into the connector in the host device, and may further acquire data indicative of the ambient temperature of the storage device 10 using a temperature sensor provided with the host device. Through this process, the host device can determine whether or not data indicative of Tc1, and data indicative of Tc2 satisfy the conditions (Tc1<Tc2, Tc1>Ta, and Tc2>Ta).

The controller 14 calculates temperature Tc1 of the upper surface with TIM and temperature Tc2 of the upper surface without TIM based on the temperature Tj measured and a thermal resistance model of heat dissipating from the controller 14 to the outside of the storage device 10. The temperature Tc2 is calculated by subtracting a product of thermal resistance θb between the lower surface and the controller 14 and the power consumption (total power consumption) Pt of the storage device, that is, θb×Pt from temperature Tj. In other words, temperature Tc2 has been lowered as the heat in the storage device 10 dissipates to the outside through the first surface 21, which is the lower surface. The temperature Tc1 is calculated by subtracting a product of thermal resistance component θb and the power consumption (total power consumption) Pt of the storage device, that is, θc×Pt from temperature Tc2. In other words, temperature Tc1 has been decreased to a temperature lower than the surface temperature Tc2 by a portion that the heat dissipates to the upper surface (second surface 22), which is caused by adding TIM to the upper surface (second surface 22).

Tc1 is a surface temperature in the case where the heat dissipates to the upper surface most efficiently, whereas Tc2 is a surface temperature in the case where the heat does not dissipate to the upper surface, and therefore the actual surface temperature is assumed to be between Tc1 and Tc2. By considering the heat dissipation structure, the host device can predict which of Tc1 and Tc2, the actual surface temperature is closer to.

As explained above, the controller 14 transmits: (1) data indicative of the temperature Tj measured by the temperature sensor 111, data indicative of temperature difference Tb′, and data indicative of temperature difference Tc′; or (2) data indicative of a certain internal temperature of the storage device 10 (for example, Tj measured by the temperature sensor 111), data indicative of the temperature Tc2 of the upper surface (second surface 22) in a case where the heat in the storage device 10 dissipates to the outside thereof through the lower surface (first surface 21), and data indicative of the temperature Tc1 of the upper surface (second surface 22) in a case where the heat in the storage device 10 dissipates to the outside thereof through both the lower surface (first surface 21) and the supper surface (second surface 22); to the host device using at least one of the signal terminals p.

Therefore, the controller 14 can provide information related to the surface temperature of the storage device 10 effective for the design and evaluation of the heat dissipation mechanism of the host device with the host device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor storage device which is capable of being placed into a host device and includes a first surface and a second surface which is placed in an opposite side of the first surface, the semiconductor storage device comprising:
a nonvolatile memory;
a controller configured to control the nonvolatile memory; and
a plurality of terminals exposed in the first surface, including a plurality of signal terminals used for signal transferring, wherein
the controller is configured to transmit first data indicative of a temperature of the controller measured by a temperature sensor, second data indicative of a temperature difference between the temperature of the controller and a temperature of the first surface, and third data indicative of a temperature difference between the temperature of the controller and a temperature of the second surface to the host device, using at least one of the signal terminals.

2. The semiconductor storage device of claim 1, wherein
the controller calculates the second data and the third data based on a thermal resistance model correlated with a power consumption of the semiconductor storage device.

3. The semiconductor storage device of claim 1, wherein
the second data is calculated as a product of a first thermal resistance between the controller and the first surface and a power consumption of the semiconductor storage device, and
the third data is calculated as a product of a second thermal resistance between the controller and the second surface and the power consumption of the semiconductor storage device.

4. The semiconductor storage device of claim 3, wherein
the power consumption of the semiconductor storage device is calculated as a sum of a power consumption of the controller and a power consumption of the nonvolatile memory,
the first thermal resistance is represented by a first linear function of a power ratio indicative of a ratio of the power consumption of the controller to the power consumption of the semiconductor storage device, and
the second thermal resistance is represented by a second linear function of the power ratio.

5. The semiconductor storage device of claim 4, wherein
the power ratio is calculated based on (i) a ratio of a power consumption of the controller in a read operation to read data from the nonvolatile memory to a power consumption of the semiconductor storage device in the read operation, (ii) a ratio of a power consumption of the controller in a write operation to write data to the nonvolatile memory to a power consumption of the semiconductor storage device in the write operation, and (iii) a number of read operations and a number of write operations executed in a first period of time.

6. The semiconductor storage device of claim 4, wherein
the power consumption of the semiconductor storage device is calculated based on (i) a power consumption of the controller in a read operation to read data from the nonvolatile memory, (ii) a power consumption of the nonvolatile memory in the read operation, (iii) a power consumption of the controller in a write operation to write data to the nonvolatile memory, (iv) a power consumption of the nonvolatile memory in the write operation, and (v) a number of read operations and a number of write operations executed in a first period of time.

7. The semiconductor storage device of claim 1, wherein
the semiconductor storage device is connectable to the host device in accordance with a NVMe specification, and
the controller is configured to transmit, in response to a request of acquiring SMART/Health Information received from the host device, the SMART/Health Information to the host device, the SMART/Health Information including the first data, the second data, and the third data.

8. The semiconductor storage device of claim 1, wherein
the semiconductor storage device is connectable to the host device in accordance with a NVMe specification, and
the controller is configured to transmit, in response to a request of acquiring SMART/Health Information received from the host device, the SMART/Health Information to the host device, the SMART/Health Information including the first data, the second data, and the third data, wherein the first data is set as a value of Composite Temperature in the SMART/Health Information.

9. The semiconductor storage device of claim 4, wherein
the controller calculates the power ratio based on a number of lanes of PCIe used in data transferring, a number of stacks of the nonvolatile memory, and power state of the semiconductor storage device.

10. The semiconductor storage device of claim 1, wherein
the semiconductor storage device is a card-shaped package.

11. A semiconductor storage device which is capable of being placed into a host device and has a first surface and a second surface which is placed in an opposite side of the first surface, the semiconductor storage device comprising:
a nonvolatile memory;
a controller configured to control the nonvolatile memory; and
a plurality of terminals exposed in the first surface, including a plurality of signal terminals used for signal transferring, wherein
the controller is configured to transmit first data indicative of an internal temperature of the semiconductor storage device, second data indicative of a temperature of the second surface in a case where heat in the semiconductor storage device dissipates to an outside of the semiconductor storage device through the first surface, and third data indicative of a temperature of the second surface in a case where the heat in the semiconductor storage device dissipates to the outside of the semiconductor storage device through the first surface and the heat further dissipates to the outside of the semiconductor storage device through the second surface, using at least one of the signal terminals.

12. The semiconductor storage device of claim 11, wherein
the controller calculates the second data and the third data based on the first data and a thermal resistance model correlated with a power consumption of the semiconductor storage device.

13. The semiconductor storage device of claim 11, wherein
the second data is calculated by subtracting a product of a first thermal resistance and the power consumption of the semiconductor storage device from the temperature of the controller, the first thermal resistance being a thermal resistance which generates a temperature difference between the controller and the second surface when the heat in the semiconductor storage device dissipates to the outside of the semiconductor storage device through the first surface, and
the third data is calculated by subtracting a product of a second thermal resistance and the power consumption of the semiconductor storage device from the second data, the second thermal resistance being a thermal resistance which decreases a temperature of the second surface below the second data in a case where the heat in the semiconductor storage device dissipates to the outside of the semiconductor storage device through the first surface and the heat further dissipates to the outside of the semiconductor storage device through the second surface.

14. The semiconductor storage device of claim 13, wherein
the power consumption of the semiconductor storage device is calculated as a sum of a power consumption of the controller and a power consumption of the nonvolatile memory,
the first thermal resistance is represented by a first linear function of a power ratio indicative of a ratio of the power consumption of the controller to the power consumption of the semiconductor storage device, and
the second thermal resistance is represented by a second linear function of the power ratio.

15. The semiconductor storage device of claim 14, wherein
the power ratio is calculated based on (i) a ratio of a power consumption of the controller in a read operation to read data from the nonvolatile memory to a power consumption of the semiconductor storage device in the read operation, (ii) a ratio of a power consumption of the controller in a write operation to write data to the nonvolatile memory to a power consumption of the semiconductor storage device in the write operation, and (iii) a number of read operations and a number of write operations executed in a first period of time.

16. The semiconductor storage device of claim 14, wherein
the power consumption of the semiconductor storage device is calculated based on (i) a power consumption of the controller in a read operation to read data from the nonvolatile memory, (ii) a power consumption of the nonvolatile memory in the read operation, (iii) a power consumption of the controller in a write operation to write data to the nonvolatile memory, (iv) a power consumption of the nonvolatile memory in the write operation, and (v) a number of read operations and a number of write operations executed in a first period of time.

17. The semiconductor storage device of claim 11, wherein
the semiconductor storage device is connectable to the host device in accordance with a NVMe specification, and
the controller is configured to transmit, in response to a request of acquiring SMART/Health Information received from the host device, the SMART/Health Information including the first data, the second data, and the third data to the host device.

18. The semiconductor storage device of claim 11, wherein
the semiconductor storage device is connectable to the host device in accordance with a NVMe specification, and
the controller is configured to transmit, in response to a request of acquiring SMART/Health Information received from the host device, the SMART/Health Information to the host device, the SMART/Health Information including the first data, the second data, and the third data, wherein the first data is set as a value of Composite Temperature in the SMART/Health Information.

19. The semiconductor storage device of claim 13, wherein
the first thermal resistance is calculated such that a product of the first thermal resistance and the power consumption of the semiconductor storage device represents a temperature difference between the temperature of the controller and the temperature of the second surface.

20. The semiconductor storage device of claim 11, wherein
the semiconductor storage device is a card-shaped package.

21. A memory system comprising:
a host device; and
a semiconductor storage device which is capable of being placed into the host device and includes a first surface and a second surface which is placed in an opposite side of the first surface,
the semiconductor storage device being connectable to the host device in accordance with a NVMe specification, and
the semiconductor storage device comprising:
a nonvolatile memory;
a controller configured to control the nonvolatile memory; and
a plurality of terminals exposed in the first surface, including a plurality of signal terminals used for signal transferring, wherein
the controller is configured to transmit first data indicative of a temperature of the controller measured by a temperature sensor, second data indicative of a temperature difference between the temperature of the controller and a temperature of the first surface, and third data indicative of a temperature difference between the temperature of the controller and a temperature of the second surface to the host device, using at least one of the signal terminals, wherein the controller transmits, in response to a request of acquiring SMART/Health Information received from the host device, the SMART/Health Information to the host device, the SMART/Health Information including the first data, the second data, and the third data, the first data being set as a value of Composite Temperature in the SMART/Health Information,
the host device is configured to read the first data set in the Composite Temperature of the SMART/Health Information sent from the semiconductor storage device and the second data and the third data set in the SMART/Health Information, and to calculate a temperature of the first surface by subtracting a product of a first distribution ratio and the second data from the first data, and a temperature of the second surface by subtracting a product of a second distribution ratio and the third data from the first data,
the first distribution ratio being a ratio to distribute a power consumption of the semiconductor storage device to the first surface, and the second distribution ratio being a ratio to distribute the power consumption of the semiconductor storage device to the second surface.

22. The memory system of claim 21, wherein
the first distribution ratio and the second distribution ratio are determined based on a heat dissipation mechanism of the host device.

23. A memory system comprising:
a host device; and
a semiconductor storage device which is capable of being placed into the host device and includes a first surface and a second surface which is placed in an opposite side of the first surface,
the semiconductor storage device comprising:
a nonvolatile memory;
a controller configured to control the nonvolatile memory; and
a plurality of terminals exposed in the first surface, including a plurality of signal terminals used for signal transferring, wherein
the controller is configured to transmit first data indicative of an internal temperature of the semiconductor storage device, second data indicative of a temperature of the second surface in a case where heat in the semiconductor storage device dissipates to an outside of the semiconductor storage device through the first surface, and third data indicative of a temperature of the second surface in a case where the heat in the semiconductor storage device dissipates to the outside of the semiconductor storage device through the first surface and the heat further dissipates to the outside of the semiconductor storage device through the second surface, using at least one of the signal terminals,
the third data is smaller than the second data, and the second data and the third data are greater than data representing an ambient temperature of the semiconductor storage device.
